(19) United States
(12) Patent Application Publication
(10) Pub. No.: US 2026/0260520 A1
(43) Pub. Date: Sep. 3, 2026

(54) ACTIVATING PALM-SCANNING SERVICE

(71) Applicant: TENCENT TECHNOLOGY (SHENZHEN) COMPANY LIMITED, Shenzhen (CN)

(72) Inventors: Qinyan ZHANG, Shenzhen (CN); Jianan WANG, Shenzhen (CN); Runzeng GUO, Shenzhen (CN); Shaoming WANG, Shenzhen (CN); Jun WANG, Shenzhen (CN); Xiaojie CHEN, Shenzhen (CN); Weipeng YAO, Shenzhen (CN); Jinming ZHANG, Shenzhen (CN); Zhenhong ZHANG, Shenzhen (CN); Jinkun HOU, Shenzhen (CN); Sizheng YANG, Shenzhen (CN); Ruixin ZHANG, Shenzhen (CN); Bowen CHEN, Shenzhen (CN); Wen GE, Shenzhen (CN); Jiayu HUANG, Shenzhen (CN); Hang ZHOU, Shenzhen (CN); Hanjie HUANG, Shenzhen (CN); Bei YANG, Shenzhen (CN); Shuqin SUN, Shenzhen (CN); Jiacheng HE, Shenzhen (CN); Litu LIANG, Shenzhen (CN)

(73) Assignee: TENCENT TECHNOLOGY (SHENZHEN) COMPANY LIMITED, Shenzhen (CN)

(21) Appl. No.: 19/655,632

(22) Filed: Apr. 22, 2026

Related U.S. Application Data
(63) Continuation of application No. PCT/CN2025/081186, filed on Mar. 7, 2025.

(30) Foreign Application Priority Data
Mar. 27, 2024 (CN) 202410372173.X

(51) Int. Cl. G06V 40/60; G06V 10/56; G06V 10/774; G06V 10/94; G06V 10/98; G06V 40/12; G06V 40/13; G06V 40/20; G06V 40/40; G06V 40/50

(52) U.S. Cl. CPC G06V 40/67; G06V 10/56; G06V 10/774; G06V 10/95; G06V 10/993; G06V 40/1312; G06V 40/1347; G06V 40/1365; G06V 40/28; G06V 40/45; G06V 40/50

(57) ABSTRACT

In a method for activating a palm-scanning service, a palm enrollment interface is displayed on a display of a terminal based on a pre-activation operation in association with a target account for the palm-scanning service and through execution of a target application by processing circuitry of the terminal. An image captured by a camera of the terminal is displayed in the palm enrollment interface. In the method, when palm information obtained from the image satisfies a palm enrollment condition, a server is notified to record pre-enrolled palm data for the target account based on the image. The server is configured to, when sample palm data for the target account collected separately from the image matches the pre-enrolled palm data, activate the palm-scanning service for the target account and record benchmark palm data for the target account according to the sample palm data.

### RELATED APPLICATIONS

The present application is a continuation of International Application No. PCT/CN2025/081186, filed on Mar. 7, 2025, which claims priority to Chinese Patent Application No. 202410372173.X, filed on Mar. 27, 2024, and entitled “METHOD FOR ACTIVATING PALM-SCANNING SERVICE AND RELATED APPARATUS.” The entire disclosures of the prior applications are hereby incorporated by reference.

### FIELD OF THE TECHNOLOGY

This disclosure relates to the field of computer technologies, including technologies related to a palm-scanning service.

### BACKGROUND OF THE DISCLOSURE

A palm-scanning service corresponds to a service performed based on palm feature information of a user. Common palm-scanning services include, but are not limited to, palm-scanning payment, palm-scanning check-in, palm-scanning membership identification, and the like. Since the palm-scanning services have high security and convenience, they have been rapidly popularized and applied in many scenarios.

In some applications, if a user intends to use a palm-scanning service, the user may need to activate the palm-scanning service first by using a dedicated offline palm-scanning device. Using activation of a palm-scanning payment service as an example, the user may need to collect a palm feature by using a palm-scanning device deployed at an offline merchant. After collecting the palm feature, the palm-scanning device may display a QR code corresponding to the collected palm feature. In this case, the user may need to scan the QR code by using a specific application to associate an account logged in on the application with the palm feature collected by the palm-scanning device. This facilitates subsequent bill deduction from the account when the palm-scanning payment service is used. In this way, the palm-scanning payment service is activated.

During activation of the palm-scanning service, the user may need to spend a long time interacting with the palm-scanning device offline to successfully activate the palm-scanning service, which results in low efficiency of activating the palm-scanning service and poor user experience, and may also affect other users from using the palm-scanning device. In addition, the palm-scanning device that supports activation of the palm-scanning service has high display requirements, that is, the palm-scanning device is required to have a large screen to display the QR code for triggering account binding, resulting in high deployment and maintenance costs of the device.

### SUMMARY

Embodiments of this disclosure provide a method for activating a palm-scanning service and a related apparatus, which can improve efficiency of activating a palm-scanning service, enhance user experience of activating the palm-scanning service, and no longer have special display requirements on a palm-scanning device that supports activation of the palm-scanning service, thereby reducing related deployment and maintenance costs of the device.

According to a first aspect, this disclosure provides a method for activating a palm-scanning service. In the method, a palm enrollment interface is displayed on a display of a terminal based on a pre-activation operation in association with a target account for the palm-scanning service and through execution of a target application by processing circuitry of the terminal. An image captured by a camera of the terminal is displayed in the palm enrollment interface. In the method, when palm information obtained from the image satisfies a palm enrollment condition, a server is notified to record pre-enrolled palm data for the target account based on the image. The server is configured to, when sample palm data for the target account collected separately from the image matches the pre-enrolled palm data, activate the palm-scanning service for the target account and record benchmark palm data for the target account according to the sample palm data.

According to a second aspect, this disclosure provides a method for activating a palm-scanning service. In the method, sample palm data is obtained through information collected by a palm-scanning device. Whether target pre-enrolled palm data matching the sample palm data exists in a pre-enrollment database is determined by processing circuitry. The target pre-enrolled palm data is obtained from an image captured by a terminal through execution of a target application. In the method, when the target pre-enrolled palm data is determined to exist and the sample palm data is collected in compliance with a device usage condition, a target account stored in association with the target pre-enrolled palm data in the pre-enrollment database is determined, the palm-scanning service for the target account is activated by the processing circuitry, and benchmark palm data for the target account is reordered according to the sample palm data.

According to a third aspect, this disclosure provides an apparatus for activating a palm-scanning service. The apparatus includes a camera, a display, and processing circuitry coupled to the display and the camera. The processing circuitry is configured to display, based on a pre-activation operation in association with a target account for the palm-scanning service and through execution of a target application by the processing circuitry, a palm enrollment interface on the display. The processing circuitry is configured to display, in the palm enrollment interface, an image captured by the camera. The processing circuitry is configured to notify, when palm information obtained from the image satisfies a palm enrollment condition, a server to record pre-enrolled palm data for the target account based on the image. The server is configured to, when sample palm data for the target account collected separately from the image matches the pre-enrolled palm data, activate the palm-scanning service for the target account and record benchmark palm data for the target account according to the sample palm data.

According to a fourth aspect, this disclosure provides an apparatus for activating a palm-scanning service. The apparatus includes processing circuitry configured to obtain sample palm data collected through a palm-scanning device. The processing circuitry is configured to determine whether target pre-enrolled palm data matching the sample palm data exists in a pre-enrollment database, the target pre-enrolled palm data being obtained from an image captured by a terminal through execution of a target application. The processing circuitry is configured to, when the target pre-enrolled palm data is determined to exist and the sample palm data is collected in compliance with a device usage condition, determine a target account stored in association with the target pre-enrolled palm data in the pre-enrollment database, activate the palm-scanning service for the target account, and record benchmark palm data for the target account according to the sample palm data.

According to a fifth aspect, this disclosure provides a method for activating a palm-scanning service, performed by a terminal, the method including: displaying, in response to a pre-activation operation on a palm-scanning service, a palm enrollment interface by using a target application running in the terminal, a target account being logged in on the target application; displaying, in the palm enrollment interface, an image captured by a camera of the terminal; and notifying, when it is determined that palm information of an object in the image satisfies a palm enrollment condition, a server to record pre-enrolled palm data corresponding to the target account, the pre-enrolled palm data being determined according to the image, and the server being configured to activate, when palm data collected by a palm-scanning device matching the pre-enrolled palm data is detected, the palm-scanning service for the target account according to the palm data.

According to a sixth aspect, this disclosure provides a method for activating a palm-scanning service, performed by a server, the method including: obtaining palm data collected by using a palm-scanning device; detecting whether target pre-enrolled palm data matching the palm data exists in a pre-enrollment database, the pre-enrollment database being configured to store an association between pre-enrolled palm data and an account, the pre-enrolled palm data being determined according to an image captured by a terminal, the image being captured by the terminal in response to a pre-activation operation on a palm-scanning service, and the account corresponding to the pre-enrolled palm data being an account logged in on a target application running in the terminal; and if the target pre-enrolled palm data is detected to exist, determining a target account corresponding to the target pre-enrolled palm data, and establishing an association between the target account and the palm data to activate the palm-scanning service for the target account.

According to a seventh aspect, this disclosure provides an apparatus for activating a palm-scanning service, including: a display module, configured to display, in response to a pre-activation operation on a palm-scanning service, a palm enrollment interface by using a target application running in a terminal, a target account being logged in on the target application; the display module being further configured to display, in the palm enrollment interface, an image captured by a camera of the terminal; and a notification module, configured to notify, when it is determined that palm information of an object in the image satisfies a palm enrollment condition, a server to record pre-enrolled palm data corresponding to the target account, the pre-enrolled palm data being determined according to the image, and the server being configured to activate, when palm data collected by a palm-scanning device matching the pre-enrolled palm data is detected, the palm-scanning service for the target account according to the palm data.

According to an eighth aspect, this disclosure provides an apparatus for activating a palm-scanning service, including: an obtaining module, configured to obtain palm data collected by using a palm-scanning device; a detection module, configured to detect whether target pre-enrolled palm data matching the palm data exists in a pre-enrollment database, the pre-enrollment database being configured to store an association between pre-enrolled palm data and an account, the pre-enrolled palm data being determined according to an image captured by a terminal, the image being captured by the terminal in response to a pre-activation operation on a palm-scanning service, and the account corresponding to the pre-enrolled palm data being an account logged in on a target application running in the terminal; and an activation module, configured to: if the target pre-enrolled palm data is detected to exist, determine a target account corresponding to the target pre-enrolled palm data, and establish an association between the target account and the palm data to activate the palm-scanning service for the target account.

According to a ninth aspect, this disclosure provides a computer device, including processing circuitry (e.g., a processor) and a memory; the memory (e.g., a non-transitory computer-readable storage medium) being configured to store a computer program; and the processor being configured to perform, according to the computer program, operations of the method for activating a palm-scanning service according to the foregoing first aspect or second aspect.

According to a tenth aspect, this disclosure provides a non-transitory computer-readable storage medium, configured to store a computer program, the computer program being configured to perform operations of the method for activating a palm-scanning service according to the foregoing first aspect or second aspect.

According to an eleventh aspect, this disclosure provides a computer program product or a computer program, including computer instructions, the computer instructions being stored in a non-transitory computer-readable storage medium. Processing circuitry (e.g., a processor) of a computer device reads the computer instructions from the non-transitory computer-readable storage medium and executes the computer instructions, to cause the computer device to perform operations of the method for activating a palm-scanning service according to the foregoing first aspect or second aspect.

In view of the foregoing technical solutions, the embodiments of this disclosure have the following advantages.

The embodiments of this disclosure provide a method for activating a palm-scanning service. The method proposes a mechanism for pre-activating a palm-scanning service by using a personal terminal. In this method, an object (e.g., a user) may preliminarily perform pre-enrollment on palm data by using a target application on a terminal, to enable a server to initially record an association between a target account currently logged in on the target application and the pre-enrolled palm data collected by the terminal. When the object uses a palm-scanning device offline, the server may automatically determine and record an association between palm data and the target account based on a match relationship between the palm data collected by the palm-scanning device and the preliminarily recorded pre-enrolled palm data, and the association between the pre-enrolled palm data and the target account. In this way, an activation operation on the palm-scanning service for the target account is completed. For the object, the palm data may be conveniently pre-enrolled preliminarily by using the personal terminal. When the palm-scanning device is used, activation of the palm-scanning service may be completed seamlessly without additional interaction with the palm-scanning device offline. Activation of the palm-scanning service is highly efficient, experience is good, and other objects are not affected from using the palm-scanning device. In addition, since the foregoing process of activating the palm-scanning service does not require the palm-scanning device to display any special content, display requirements on the palm-scanning device are reduced, thereby correspondingly lowering deployment and maintenance costs of the device.

### BRIEF DESCRIPTION OF THE DRAWINGS

FIG. 1 is a schematic diagram of an application scenario of a method for activating a palm-scanning service according to an embodiment of this disclosure.

FIG. 2 is a schematic flowchart of a method for activating a palm-scanning service according to an embodiment of this disclosure.

FIG. 3 is a schematic diagram 1 of a palm enrollment interface according to an embodiment of this disclosure.

FIG. 4 is a schematic diagram 2 of a palm enrollment interface according to an embodiment of this disclosure.

FIG. 5 is a schematic diagram 3 of a palm enrollment interface according to an embodiment of this disclosure.

FIG. 6 is a schematic diagram 4 of a palm enrollment interface according to an embodiment of this disclosure.

FIG. 7 is a schematic flowchart of a server recording pre-enrolled palm data according to an embodiment of this disclosure.

FIG. 8 is a schematic diagram of an interface of a terminal side during pre-activation of a palm-scanning service according to an embodiment of this disclosure.

FIG. 9 is a schematic diagram of detection of a palm enrollment condition according to an embodiment of this disclosure.

FIG. 10 is a schematic diagram of determining a position relationship between a palm and a reference boundary according to an embodiment of this disclosure.

FIG. 11 is a schematic diagram of a first key point according to an embodiment of this disclosure.

FIG. 12 is a schematic diagram of determining palm direction information according to an embodiment of this disclosure.

FIG. 13 is a schematic diagram of determining image quality information according to an embodiment of this disclosure.

FIG. 14 is a schematic diagram of living palm detection according to an embodiment of this disclosure.

FIG. 15 is a schematic diagram of a second key point according to an embodiment of this disclosure.

FIG. 16 is a schematic diagram of determining a gesture based on a second key point according to an embodiment of this disclosure.

FIG. 17 is a schematic flowchart of another method for activating a palm-scanning service according to an embodiment of this disclosure.

FIG. 18 is a schematic flowchart of a server providing a palm-scanning service according to an embodiment of this disclosure.

FIG. 19 is a schematic diagram of an interface of a palm-scanning device side according to an embodiment of this disclosure.

FIG. 20 is a schematic diagram of a structure of an apparatus for activating a palm-scanning service according to an embodiment of this disclosure.

FIG. 21 is a schematic diagram of a structure of another apparatus for activating a palm-scanning service according to an embodiment of this disclosure.

FIG. 22 is a schematic diagram of a structure of a terminal device according to an embodiment of this disclosure.

FIG. 23 is a schematic diagram of a structure of a server according to an embodiment of this disclosure.

### DETAILED DESCRIPTION

Embodiments of this disclosure are described below with reference to the accompanying drawings. The described embodiments are merely some rather than all of the embodiments of this disclosure. Other embodiments are within the scope of the disclosure.

Examples of terms involved in the aspects of the disclosure are briefly introduced. The descriptions of the terms are provided as examples only and are not intended to limit the scope of the disclosure.

In the specification, claims, accompanying drawings of this disclosure, the terms “first”, “second”, “third”, “fourth”, and the like (if existing) are intended to distinguish between similar objects rather than describe a specific sequence or a precedence order. Data used in such a way are interchangeable in proper circumstances, so that the embodiments of this disclosure described herein can be implemented in other orders than the order illustrated or described herein. Moreover, the terms “include”, “have”, and any other variants thereof mean to cover the non-exclusive inclusion. For example, a process, method, system, product, or device that includes a list of operations or units is not necessarily limited to those operations or units that are listed, but may include other operations or units not expressly listed or inherent to such a process, method, system, product, or device.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

A method for activating a palm-scanning service provided in an embodiment of this disclosure may be performed by a computer device, and the computer device may be a terminal device or a server. The terminal device includes, but is not limited to, a mobile phone, a computer, a smart speech interaction device, a smart household appliance, an in-vehicle terminal, an aircraft, and the like. The server may be an independent physical server, or may be a server cluster including a plurality of physical servers or a distributed system, or may be a cloud server.

In addition, information (such as account information), data (such as palm data), and signals involved in the embodiments of this disclosure are all authorized by the related object or fully authorized by each party, and collection, use, and processing of relevant data need to comply with relevant laws and regulations of relevant countries and regions.

For ease of understanding the method for activating a palm-scanning service provided in this embodiment of this disclosure, the following describes an application scenario of the method for activating a palm-scanning service provided in this embodiment of this disclosure as a non-limiting example.

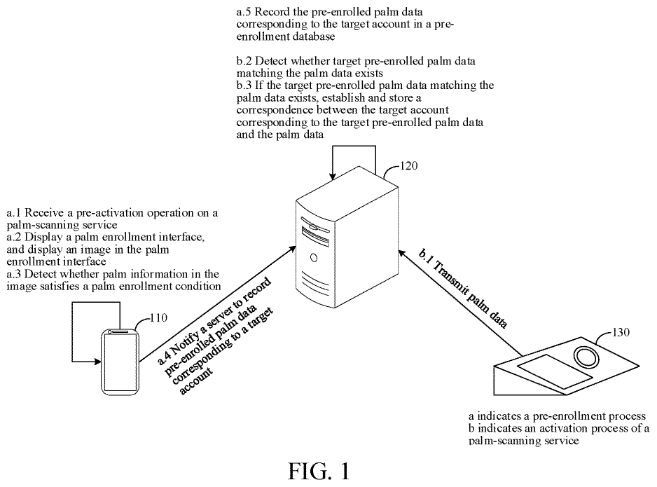

FIG. 1 is a schematic diagram of an application scenario of a method for activating a palm-scanning service according to an embodiment of this disclosure. As shown in FIG. 1, the application scenario includes a terminal 110, a server 120, and a palm-scanning device 130. The terminal 110 may communicate with the server 120 by using a network, and the palm-scanning device 130 may also communicate with the server 120 by using the network.

The terminal 110 is a personal terminal of an object (e.g., a user). In the personal terminal, a target application associated with a palm-scanning service is running, for example, a payment application that supports registering an account and activating a palm-scanning payment service. The terminal 110 is configured to perform the method for activating a palm-scanning service provided in the embodiments of this disclosure on a terminal side. The server 120 is configured to perform the method for activating a palm-scanning service provided in the embodiments of this disclosure on a server side, to activate and provide the palm-scanning service for a user of the target application. The palm-scanning device 130 is a dedicated offline-deployed device specifically configured to collect palm data. The server 120 needs to activate and provide the palm-scanning service for the user of the target application based on the palm data collected by the palm-scanning device 130.

In some examples, the object may trigger a pre-activation operation on the palm-scanning service by using the target application running in the terminal 110. The terminal 110 displays, in response to the pre-activation operation, a palm enrollment interface by using the target application, and displays, in the palm enrollment interface, an image captured by using a camera of the terminal 110. When it is determined, through detection, that palm information of the object in the image satisfies a palm enrollment condition, the terminal 110 may notify the server to record pre-enrolled palm data corresponding to the target account currently logged in on the target application. The pre-enrolled palm data may be determined according to the foregoing image. For example, the terminal 110 may transmit a notification message carrying the pre-enrolled palm data determined according to the image to the server 120, to notify the server 120 to record an association between the target account logged in on the target application in the terminal 110 and the pre-enrolled palm data.

After receiving the notification message of the terminal 110, the server 120 may correspondingly record the target account and the pre-enrolled palm data corresponding to the target account into a pre-enrollment database, thereby completing a palm pre-enrollment operation for the target account.

Subsequently, the object may go to the offline-deployed palm-scanning device 130, and palm-scanning is performed by using the palm-scanning device 130, so that the palm-scanning device 130 collects palm data of the object, and transmits the palm data to the server 120 by using the network. After obtaining the palm data, the server 120 may detect, in the pre-enrollment database, whether target pre-enrolled palm data matching the palm data exists. If it is detected that the target pre-enrolled palm data exists, the object currently performing palm-scanning by using the palm-scanning device 130 has completed the palm pre-enrollment operation previously. In this case, the server 120 may determine the target account corresponding to the target pre-enrolled palm data, and establish and store an association between the target account and the palm data collected by the palm-scanning device 130, thereby completing an activation operation on the palm-scanning service for the target account.

Since an image capturing member with better performance may be deployed on the palm-scanning device 130, for example, a red green blue (RGB) image capturing camera and an infrared camera are both deployed, the palm data collected by the palm-scanning device 130 has higher reliability than the pre-enrolled palm data collected by the terminal 110. Correspondingly, the association between the target account and the palm data is recorded in a backend, and the palm-scanning service is subsequently provided for the object according to the association, which can enhance reliability of the palm-scanning service.

During activation of the foregoing palm-scanning service, the object can conveniently complete pre-enrollment of the palm data preliminarily by using the personal terminal 110. When subsequently using the palm-scanning device 130 offline, the object can complete activation of the palm-scanning service seamlessly without additional interaction with the palm-scanning device 130 offline. Activation of the palm-scanning service is highly efficient, experience is good, and other objects are not affected from using the palm-scanning device 130. In addition, since the foregoing process of activating the palm-scanning service does not require the palm-scanning device 130 to display any special content, display requirements on the palm-scanning device are reduced, thereby correspondingly lowering deployment and maintenance costs of the device.

The application scenario shown in FIG. 1 is only an example. In some examples, the method for activating a palm-scanning service provided in the embodiments of this disclosure may alternatively be applied in other scenarios, and an application scenario of the method for activating a palm-scanning service provided in the embodiments of this disclosure is not limited herein.

The following describes in detail the method for activating a palm-scanning service provided in this disclosure by using method embodiments.

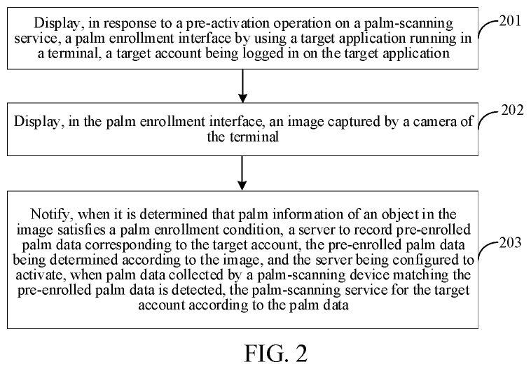

FIG. 2 is a schematic flowchart of a method for activating a palm-scanning service according to an embodiment of this disclosure. The method for activating a palm-scanning service may be performed by a terminal, or may be jointly performed by a terminal and a server. As shown in FIG. 2, the method for activating a palm-scanning service includes the following operations.

Operation 201: Display, in response to a pre-activation operation on a palm-scanning service, a palm enrollment interface by using a target application running in a terminal, a target account being logged in on the target application. For example, a palm enrollment interface is displayed on a display of a terminal based on a pre-activation operation in association with a target account for the palm-scanning service and through execution of a target application by processing circuitry of the terminal.

In this embodiment of this disclosure, the terminal may display, in response to the pre-activation operation performed by an object on the palm-scanning service, the palm enrollment interface by using the target application running in the terminal, enabling interaction with the object by using the palm enrollment interface to pre-enroll palm data of the object.

The terminal is a terminal device oriented to a personal object, and may be, for example, a smartphone, a tablet computer, or an intelligent wearable device that is used by a person. In this disclosure, the personal object oriented to the terminal is referred to as a target object. The terminal runs the target application, and the target application may be any application associated with the palm-scanning service. For example, the target application may be an application program having a payment function, and supports the user to activate and use a palm-scanning payment service. When the user uses the palm-scanning payment service offline, bill deduction may be automatically performed from an account of the user in the target application. In this disclosure, the account that is currently logged in on the target application running on the terminal is referred to as a target account.

The palm-scanning service may be any service performed based on the palm data, for example, may be a palm-scanning payment service, a palm-scanning check-in service, a palm-scanning identity recognition service, a palm-scanning riding service, or a palm-scanning resource loan service. Specific service content of the palm-scanning service is not limited in the embodiments of this disclosure. The pre-activation operation on the palm-scanning service is an operation triggered by a personal terminal to activate the palm-scanning service. Since the operation triggered by the personal terminal to activate the palm-scanning service cannot complete activation of the palm-scanning service, and the operation triggered by the personal terminal to activate the palm-scanning service is only a link during activation of the palm-scanning service, the operation triggered by the personal terminal to activate the palm-scanning service is referred to as the pre-activation operation on the palm-scanning service. To complete activation of the palm-scanning service in some examples, the related object further needs to go to an offline palm-scanning device, to complete enrollment of the palm data with higher reliability.

As an example, the object may trigger the pre-activation operation on the palm-scanning service in the following manner. The object may scan, by using a code scanning function provided by the target application running in the terminal, a QR code configured for triggering activation of the palm-scanning service, thereby triggering the pre-activation operation on the palm-scanning service. Alternatively, the object may search the target application for an activation entry of the palm-scanning service, thereby triggering the pre-activation operation on the palm-scanning service by clicking the activation entry. For example, the object may search the target application for a mini program providing the palm-scanning service, and further trigger the pre-activation operation on the palm-scanning service by using the activation entry of the palm-scanning service provided by the mini program. Alternatively, a palm-scanning service promotion link may be displayed in a specific page (such as a payment voucher page, a payment code payment page, a payment result page, an official account page, or a mini program page) of the target application. The object may trigger display of an introduction page of the palm-scanning service by clicking the palm-scanning service promotion link. The activation entry of the palm-scanning service may be deployed in the introduction page, and the object may trigger the pre-activation operation on the palm-scanning service by clicking the activation entry.

The foregoing manner of triggering the pre-activation operation on the palm-scanning service is only an example. In some examples, another manner of triggering the pre-activation operation may also be set according to actual service requirements. The manner of triggering the pre-activation operation is not limited in the embodiments of this disclosure.

The palm enrollment interface is a user interface displayed by the target application in response to the pre-activation operation on the palm-scanning service. The palm enrollment interface is configured to interact with the object to collect the palm data of the object. Specifically, related prompt information may be displayed in the palm enrollment interface, to instruct the object to place a palm of the object in a specific data collection region and in a specific state, so that it is convenient for the terminal to collect the palm data of the object.

Operation 202: Display, in the palm enrollment interface, an image captured by a camera of the terminal.

In the palm enrollment interface displayed by the target application, the image captured by the camera of the terminal is displayed. The camera of the terminal may be a camera component integrated in the terminal, or may be a camera component external to the terminal. The image captured by the camera of the terminal and displayed in the palm enrollment interface may also be referred to as a basic image.

In this embodiment of this disclosure, to complete the pre-activation operation on the palm-scanning service, the image including the palm of the object needs to be obtained by using the terminal. To facilitate the object to perform palm enrollment, that is, to facilitate the terminal to accurately capture the image including the palm of the object, a manner of visually displaying, in the palm enrollment interface, the image captured by the camera of the terminal may be used to make the object learn the image currently captured by the camera of the terminal and make the object place the palm of the object in an image capturing region of the camera of the terminal in a targeted manner, so that the terminal can conveniently capture the image including the palm of the object.

In addition, to improve the likelihood that pre-enrolled palm data collected through the pre-activation operation on the palm-scanning service can be accurately matched with the palm data collected by using the palm-scanning device subsequently, a palm enrollment condition further needs to be set, that is, only when palm information in the image captured by the camera of the terminal satisfies the palm enrollment condition, the backend can be triggered to enroll the corresponding pre-enrolled palm data. The palm enrollment condition may specify a standard palm placement state, that is, a subsequent data enrollment process may be performed only when the palm in the image satisfies the palm placement state. In addition, the palm enrollment condition may further specify a liveness detection condition, that is, a subsequent data enrollment process may be performed only when the palm in the basic image is detected as a living palm (that is, a palm of a living human object).

In a possible implementation, to facilitate the object to efficiently complete pre-enrollment of the palm data by using the terminal, the method provided in this embodiment of this disclosure further includes displaying prompt information in the palm enrollment interface, the prompt information being configured for indicating an action to be performed by a palm to satisfy the palm enrollment condition. For example, prompt information is displayed in the palm enrollment interface, where the prompt information indicates a proposed action based on a palm enrollment condition.

That is, the terminal may further display the prompt information in the palm enrollment interface. The prompt information is configured for helping the object to make the palm information of the object in the image satisfy the palm enrollment condition. The prompt information may specifically indicate an action that the object needs to control the palm of the object to perform, for example, control the palm of the object to be placed at a specific position, control the palm of the object to be adjusted to a specific state, or control the palm of the object to perform a specific action.

In this way, display of the prompt information in the palm enrollment interface can help the object to more quickly control the palm of the object to reach the state specified by the palm enrollment condition, so that the palm information in the image satisfies the palm enrollment condition, thereby improving efficiency of palm data pre-enrollment on the terminal side.

As an example, when the image captured by the camera does not include the palm, position prompt information may be displayed in the palm enrollment interface. The position prompt information is configured for indicating a position at which the palm is to be located relative to the terminal. In some examples, position prompt information is displayed in the palm enrollment interface when the image does not depict a palm, the position prompt information indicating a position at which the palm is to be located relative to the terminal.

That is, the terminal may detect whether the image currently captured by the camera includes the palm. If it is determined, through detection, that the image does not include the palm, the position prompt information needs to be displayed in the palm enrollment interface, to prompt the target object to place the palm of the target object in the image capturing region of the camera. To facilitate the object to learn of a specific palm placement position, the position prompt information may indicate the position at which the palm is to be located relative to the terminal. That is, it is convenient for the object to accurately place the palm of the object in the image capturing region of the camera by using the terminal as reference.

FIG. 3 is a schematic diagram of a palm enrollment interface according to an embodiment of this disclosure. As shown in FIG. 3, the image displayed in the palm enrollment interface does not include the palm, that is, the palm of the object is not currently located in the image capturing region of the camera of the terminal. In this case, position prompt information “Please place a commonly used palm at the rear of the mobile phone” may be displayed in the palm enrollment interface, to prompt the object to place the palm of the object in the image capturing region of the camera, so that the image captured by the camera includes the palm of the object.

As another example, when the image captured by the camera includes the palm but a current placement state of the palm is not consistent with a standard placement state, adjustment prompt information may be displayed in the palm enrollment interface. The adjustment prompt information is configured for indicating an action to be performed by the palm to change from the current placement state to the standard placement state. In some examples, adjustment prompt information is displayed in the palm enrollment interface when the image depicts the palm and indicates that a current placement state of the palm is inconsistent with a standard placement state, the adjustment prompt information indicating an action to be taken by the palm to change the palm from the current placement state to the standard placement state.

Specifically, in a case that the terminal determines, through detection, that the image currently captured by the camera includes the palm, the terminal may further detect a placement state of the palm in the image, to detect whether the current placement state of the palm is consistent with the standard placement state. The standard placement state may be preset. For example, a standard distance interval may be set for a distance between the palm and the camera, and a standard angle interval may be set for a placement angle of the palm. The placement state of the palm satisfies the standard placement state is a premise that the palm information in the image satisfies the palm enrollment condition.

If it is determined, through detection, that the current placement state of the palm does not match the standard placement state, the adjustment prompt information needs to be displayed in the palm enrollment interface, to prompt the object to adjust the placement state of the palm. To facilitate the object to learn a specific adjustment manner, the adjustment prompt information may indicate an action to be performed by the palm to change from the current placement state to the standard placement state, that is, the adjustment prompt information is automatically designed according to a difference between the current placement state of the palm and the standard placement state, to help the object to more quickly control the palm to reach the standard placement state.

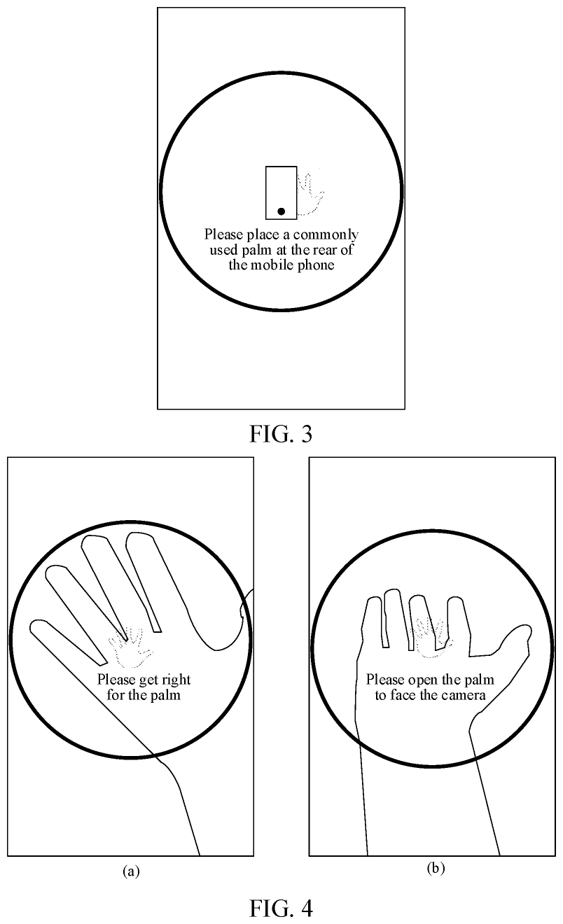

FIG. 4 is a schematic diagram of another palm enrollment interface according to an embodiment of this disclosure. As shown in (a) in FIG. 4, the image displayed in the palm enrollment interface includes the palm, but the current placement state of the palm is inconsistent with the standard placement state (for example, it is stipulated that an angle of the palm in the image is to be within a specific angle interval). In this case, adjustment prompt information “Please get right for the palm” may be displayed in the palm enrollment interface, to prompt the object to adjust a placement angle of the palm. As shown in (b) in FIG. 4, the image displayed in the palm enrollment interface includes the palm, but the current placement state of the palm is inconsistent with the standard placement state (for example, it is stipulated that the palm faces the camera). In this case, adjustment prompt information “Please open the palm to face the camera” may be displayed in the palm enrollment interface, to prompt the object to adjust a placement posture of the palm.

Further, to facilitate the object to more quickly and accurately adjust the placement state of the palm to the standard placement state, the terminal may display, in the palm enrollment interface, a first reference identifier corresponding to the standard placement state and a second reference identifier corresponding to the current placement state. Further, the adjustment prompt information is displayed according to a relationship between the first reference identifier and the second reference identifier. The adjustment prompt information is configured for indicating an action to be performed by the palm to adjust the second reference identifier to match the first reference identifier.

Specifically, the terminal may display the first reference identifier configured for indicating the standard placement state and the second reference identifier configured for indicating the current placement state of the palm of the object in the palm enrollment interface. The object may intuitively learn of a difference between the current placement state of the palm of the object and the standard placement state that needs to be reached by using the first reference identifier and the second reference identifier. To make the object clearer about an adjustment manner for the palm, the adjustment prompt information may further be displayed according to the relationship between the first reference identifier and the second reference identifier. For example, an arrow indication sign (for example, indicating a movement direction or a rotation direction of the palm) or text indication information (for example, indicating that the palm approaches the camera or moves away from the camera) configured for indicating matching the second reference identifier with the first reference identifier is displayed.

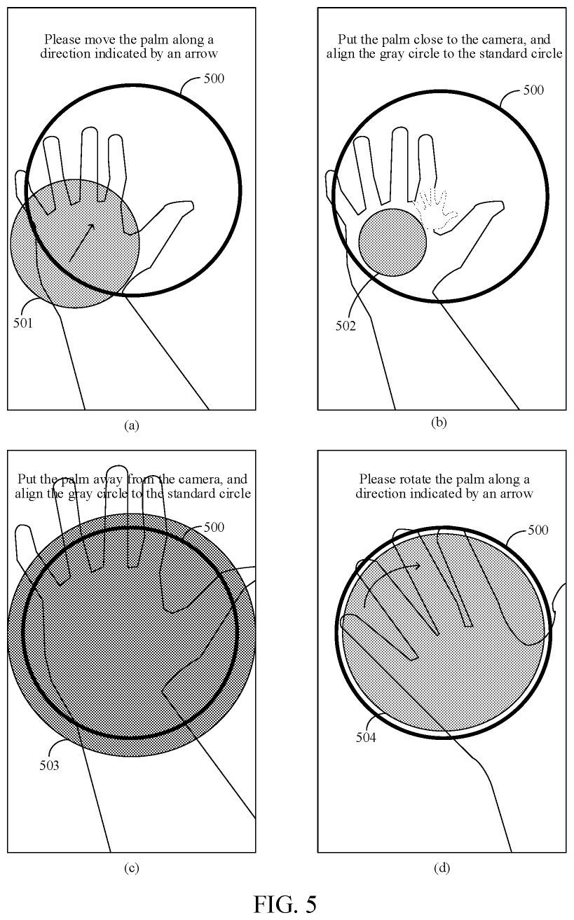

FIG. 5 is a schematic diagram of still another palm enrollment interface according to an embodiment of this disclosure. As shown in (a) to (d) in FIG. 5, a first reference identifier 500 that corresponds to the standard placement state and that has no background color is displayed in the palm enrollment interface, and a second reference identifier 501 (FIG. (a)), a second reference identifier 502 (FIG. (b)), a second reference identifier 503 (FIG. (c)), and a second reference identifier 504 (FIG. (d)) that correspond to the current placement state and that have a background color are further displayed.

In FIG. (a), there is a position deviation between the second reference identifier 501 and the first reference identifier 500. In this case, adjustment prompt information in a form of an arrow is displayed in the palm enrollment interface, and is configured for instructing the object to control the palm to move in a direction pointed by the arrow. The arrow may be specifically an arrow pointing from a circle center of the second reference identifier 501 to a circle center of the first reference identifier 500.

In FIG. (b), an area of the second reference identifier 502 is less than an area of the first reference identifier 500, which indicates that a current placement position of the palm is excessively far away from the camera. In this case, adjustment prompt information “Put the palm close to the camera, and align the gray circle to the standard circle” in a form of a text is displayed in the palm enrollment interface, and is configured for instructing the object to control the palm to move in a direction close to the camera. A diameter of the foregoing second reference identifier 502 may be determined according to a current distance between the palm and the camera and a distance between a standard placement position and the camera. Specifically, a ratio of the current distance between the palm and the camera to the distance between the standard placement position and the camera may be calculated, and the ratio is multiplied by a focal length of the camera, to calculate the diameter of the second reference identifier 502. Alternatively, a proportion of a coverage area of the palm in the basic image in the first reference identifier 500 may be calculated, and the diameter of the second reference identifier 502 is calculated according to the proportion and a diameter of the first reference identifier 500.

In FIG. (c), the area of the second reference identifier 503 is greater than the area of the first reference identifier 500, which indicates that the current placement position of the palm is excessively close to the camera. In this case, adjustment prompt information “Put the palm away from the camera, and align the gray circle to the standard circle” in the form of a text is displayed in the palm enrollment interface, and is configured for instructing the object to control the palm to move in a direction away from the camera. In addition, when the current placement position of the palm is excessively close to the camera, the background color of the second reference identifier 503 may change, that is, the background color of the second reference identifier 503 is different from the background color of the second reference identifier 502, to distinguish whether the palm currently needs to move in the direction close to the camera or needs to move in the direction away from the camera.

In FIG. (d), the second reference identifier 504 matches the first reference identifier 500, but a placement angle of the palm in the image is not consistent with an angle specified by the standard placement state. In this case, the adjustment prompt information in the form of an arrow is displayed in the palm enrollment interface, and is configured for instructing the object to control the palm to rotate in a direction pointed by the arrow. The rotation direction indicated by the arrow may be determined according to a relative relationship between a current placement angle of the palm and an angle stipulated by the standard placement state.

In this way, by using the first reference identifier configured for indicating the standard placement state and the second reference identifier configured for indicating the current placement state, the object can learn of the difference between the current placement state of the palm of the object and the required standard placement state more intuitively, so that the placement state of the palm can be adjusted more accurately according to the difference between the second reference identifier and the first reference identifier, and the placement state of the palm in the image quickly reaches the required standard placement state, thereby improving efficiency of palm data pre-enrollment.

As another example, when the image includes the palm and the current placement state of the palm is consistent with the standard placement state, verification prompt information may be displayed in the palm enrollment interface. The verification prompt information is configured for indicating a liveness verification action to be performed by the palm. In some examples, verification prompt information is displayed in the palm enrollment interface when the image depicts the palm and indicates that the current placement state of the palm is consistent with the standard placement state, the verification prompt information indicating a liveness verification action to be performed by the palm.

Specifically, in a case that the terminal determines, through detection, that the image currently captured by the camera includes the palm, and the current placement state of the palm is consistent with the standard placement state, the terminal may further perform liveness verification on the palm in the image to verify whether the palm belongs to a living object.

Specifically, when liveness verification is performed, the terminal may display the verification prompt information in the palm enrollment interface, and instruct, by using the verification prompt information, the object to control the palm to perform a specific liveness verification action, for example, instruct the object to control the palm to perform an action of making a fist. A non-living palm cannot perform the specific liveness verification action. For example, a palm attacked by using an image (that is, the palm displayed in the image) cannot be controlled to perform a specific hand action. Therefore, whether the palm in the image can successfully perform the indicated liveness verification action may be verified, to determine whether the object currently pre-enrolling the palm data is a living object.

FIG. 6 is a schematic diagram of still another palm enrollment interface according to an embodiment of this disclosure. As shown in (a) in FIG. 6, verification prompt information “Please make a fist” may be displayed in the palm enrollment interface, to instruct the object to control the palm to perform an action of making a fist. When the palm in the image is in a fist state, as shown in (b) in FIG. 6, verification prompt information “Please keep closing the fist” may be displayed in the palm enrollment interface, to instruct the object to continue to control the palm to perform the action of making a fist. If the palm in the image continues to be in the indicated fist state, it may be considered that palm enrollment is currently performed by the living object, and it is determined that liveness verification succeeds.

In this way, by using the foregoing position prompt information, adjustment prompt information, verification prompt information, and other prompt information, corresponding interactive guidance prompts are provided to the object, which can help the object to quickly and accurately control the palm to reach the specified state, so that the palm information in the image can quickly satisfy the palm enrollment condition and improve efficiency of palm data pre-enrollment.

The forms of the prompt information displayed in FIG. 3 to FIG. 6 are only examples. In some examples, various forms of the prompt information may be set according to actual requirements. This is not limited in the embodiments of this disclosure.

In an embodiment, before the image is displayed by using the palm enrollment interface, an enrolled palm selection control may further be displayed in the palm enrollment interface, so that the object selects the currently enrolled palm as a left hand or a right hand by using the enrolled palm selection control. In this way, memory of the object for the palm enrolled by using the terminal is enhanced, to avoid that the object cannot successfully activate the palm-scanning service because the object forgets the enrolled palm when going to the offline palm-scanning device to complete an activation operation on the palm-scanning service, or the object consumes a long time to activate the palm-scanning service.

Operation 203: Notify, when it is determined that palm information of an object in the image satisfies a palm enrollment condition, a server to record pre-enrolled palm data corresponding to the target account, the pre-enrolled palm data being determined according to the image, and the server being configured to activate, when palm data collected by a palm-scanning device matching the pre-enrolled palm data is detected, the palm-scanning service for the target account according to the palm data. For example, when palm information obtained from the image satisfies a palm enrollment condition, a server is notified to record pre-enrolled palm data for the target account based on the image. The server may be configured to, when sample palm data collected by a palm-scanning device matches the pre-enrolled palm data and before activation of the palm-scanning service for the target account, activate the palm-scanning service for the target account and record benchmark palm data for the target account according to the sample palm data.

In some embodiments, the image (from which the pre-enrolled palm data is obtained) is taken by the camera of the terminal within a visible-light spectrum; and one or more candidate images (from which the benchmark palm data is obtained) are taken by the palm-scanning service within a visible-light spectrum, an infrared spectrum, or both.

In a process of capturing the image by using the camera, the terminal may further detect the palm in the image, that is, detect whether the palm information of the object in the image satisfies the palm enrollment condition. As described above, the palm enrollment condition is a basic condition for triggering the server in the backend to record the pre-enrolled palm data, that is, only when the palm information in the image satisfies the palm enrollment condition, the server in the backend can be triggered to record the palm data currently collected by the terminal as the pre-enrolled palm data. In some embodiments, the palm enrollment condition may include an image quality condition and a palm liveness condition. The image quality condition requires that the palm in the image is displayed, and the palm liveness condition requires that the palm in the image is a palm of a living object. A mechanism for detecting whether the palm enrollment condition is satisfied is described in detail below, and details are not described herein again.

In a case that the terminal determines, through detection, that the palm information of the object in the image satisfies the palm enrollment condition, the terminal may transmit a notification message to the server in the backend configured to manage and provide the palm-scanning service, to notify the server to record the association between the target account (that is, the account currently logged in on the target application running in the target terminal) and the pre-enrolled palm data, thereby completing pre-activation of the palm-scanning service for the target account. The pre-enrolled palm data corresponding to the target account may be determined according to the image captured by the terminal, and may be specifically obtained by performing palm feature extraction processing on the image satisfying the image quality condition.

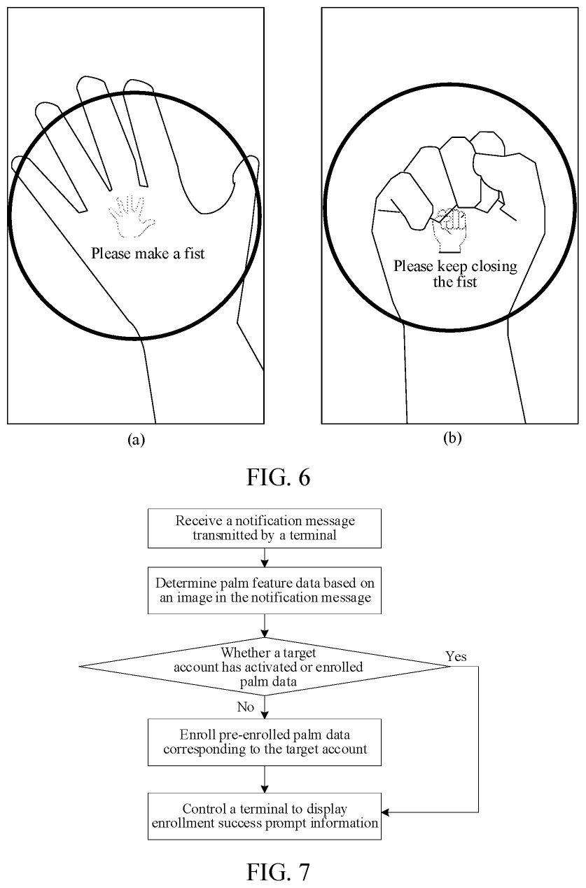

For example, FIG. 7 is a schematic flowchart of a server recording pre-enrolled palm data according to an embodiment of this disclosure. As shown in FIG. 7, the terminal may transmit a notification message carrying the target account and the image satisfying the image quality condition to the server. After receiving the notification message, the server may perform palm feature extraction processing on the image in the notification message, to obtain corresponding palm feature data. Further, the server detects, in a pre-enrollment database configured to store an association between pre-enrolled palm data and an account, whether pre-enrolled palm data matching the palm feature data exists, and whether the account corresponding to the pre-enrolled palm data is the target account. If it is detected that the matching pre-enrolled palm data exists, and the account corresponding to the matching pre-enrolled palm data is the target account, the object has pre-activated the palm-scanning service previously. In this case, the terminal may be directly controlled to display enrollment success prompt information. If the matching pre-enrolled palm data is not detected, or it is detected that the account corresponding to the matching pre-enrolled palm data is not the target account, the palm feature data may be used as the pre-enrolled palm data corresponding to the target account, and the association between the pre-enrolled palm data and the target account is stored in the foregoing pre-enrollment database. Further, the terminal is controlled to display the enrollment success prompt information. In this way, the pre-activation operation on the palm-scanning service for the target account is completed.

When the object subsequently uses the offline palm-scanning device, the palm-scanning device may correspondingly collect the palm data of the object, and transmit the collected palm data to the server configured to manage and provide the palm-scanning service. The server may detect, based on the palm data, the previously recorded pre-enrolled palm data matching the palm data. In this case, the server may determine that the object for which the palm-scanning service is pre-activated by using the terminal is currently using the palm-scanning device. Correspondingly, the server may complete the corresponding activation operation on the palm-scanning service based on the palm data collected by the palm-scanning device, that is, replace the previously recorded pre-enrolled palm data with the palm data collected by the palm-scanning device, and store the association between the target account and the palm data, thereby completing the activation operation on the palm-scanning service for the target account.

A configuration of the camera of the terminal may be low in some embodiments, and therefore the pre-enrolled palm data determined based on the image captured by the camera of the terminal is usually not reliable enough. A camera with a high configuration is usually deployed on the palm-scanning device. For example, a camera for capturing an RGB image and an infrared camera are both configured. Therefore, dual-factor palm data collected by the palm-scanning device has high reliability. In this embodiment of this disclosure, the palm data collected by the palm-scanning device is used to replace the pre-enrolled palm data. In this way, it is considered that the activation operation on the palm-scanning service is completed, so that reliability of the palm-scanning service can be effectively enhanced.

In a possible implementation, the method provided in this embodiment of this disclosure may further include displaying an identity verification interface by using the target application, the identity verification interface being configured to verify an association relationship between the object and the target account; and notifying, when it is determined that the association relationship between the object and the target account passes verification, the server to record the pre-enrolled palm data corresponding to the target account. In some examples, an identity verification interface is displayed through the execution of the target application by the processing circuitry, the identity verification interface being configured to verify an association relationship between the palm information and the target account. In some examples, the notifying the server to record the pre-enrolled palm data for the target account includes notifying, when the association relationship between the palm information and the target account is successfully verified, the server to record the pre-enrolled palm data for the target account.

Specifically, in a process of enrolling the pre-enrolled palm data corresponding to the target account by using the terminal, the identity verification interface may further be displayed by using the target application, to verify the association relationship between the object and the target account by using the identity verification interface, that is, verify whether the object is a legal user of the target account.

In the identity verification interface, any verification manner capable of verifying the association relationship between the object and the target account may be used. For example, the identity verification interface may verify the association relationship between the object and the target account by using a password input manner. For example, a password input control is displayed in the identity verification interface, and the object currently performing palm data pre-enrollment is required to input a password (for example, a password of a payment service) of the target account, thereby verifying whether the input password is consistent with an actual password of the target account. Alternatively, the identity verification interface may verify the association relationship between the object and the target account by using a facial verification manner. For example, a face image of the object currently performing palm data enrollment is captured based on the identity verification interface, and then whether a face feature in the face image matches a standard face feature (a face feature pre-enrolled by the legal user of the target account) corresponding to the target account is verified. In some examples, another verification manner may alternatively be used to verify the association relationship between the object and the target account. This is not limited in the embodiments of this disclosure.

The identity verification interface may be displayed before the palm enrollment interface, that is, after receiving the pre-activation operation on the palm-scanning service, the terminal first displays the identity verification interface, and verifies the association relationship between the object and the target account by using the identity verification interface. If verification succeeds, the palm enrollment interface is displayed to pre-enroll the palm data of the object; and if verification fails, the subsequent process of palm data pre-enrollment is not executed. Alternatively, the identity verification interface may be displayed after the palm enrollment interface, that is, after capturing, by using the palm enrollment interface, the image satisfying the image quality condition, the terminal may display the identity verification interface, to verify the association relationship between the object and the target account by using the identity verification interface. If verification succeeds, the image satisfying the image quality condition is transmitted to the server, to notify the server to record, according to the image, the pre-enrolled palm data corresponding to the target account; and if verification fails, the notification message is not transmitted to the server, and it is considered that the pre-activation operation on the palm-scanning service fails.

In this way, in a process of pre-activating the palm-scanning service by using the terminal, the association relationship between the object currently performing palm data enrollment and the target account currently logged in on the target application is verified by using the identity verification interface, to improve the chance that the pre-enrolled palm data is the palm data of the legal user of the target account, thereby enhancing security of the palm-scanning service.

In a possible implementation, the method provided in this embodiment of this disclosure may further include displaying palm-scanning device prompt information, the palm-scanning device prompt information being configured for indicating a device usage condition to be satisfied when the palm-scanning service is activated for the target account based on the pre-enrolled palm data, and the device usage condition being configured for indicating at least one of a geographical location range or a usage time range corresponding to the palm-scanning device to be used. In some examples, palm-scanning device prompt information is displayed on the display of the terminal, the palm-scanning device prompt information indicating a device usage condition for the activation of the palm-scanning service for the target account based on the pre-enrolled palm data, and the device usage condition indicating that the sample palm data is collected through the palm-scanning device located within a geographical range or within a time range.

Specifically, in a mechanism for activating the palm-scanning service provided in this embodiment of this disclosure, if the activation operation on the palm-scanning service is completed based on the pre-enrolled palm data enrolled by the terminal, the object further needs to go to the offline palm-scanning device to collect palm data of higher quality. Based on this, in this embodiment of this disclosure, a device usage condition may be further specified. That is, if the object intends to complete activation of the palm-scanning service for the target account based on the previously enrolled pre-enrolled palm data, the object needs to use the offline palm-scanning device according to the device usage condition. That is, only when the server in the backend detects that use of the palm-scanning device by the object satisfies the device usage condition, the server in the backend completes activation of the palm-scanning service for the target account based on the palm data collected by the palm-scanning device.

Specifically, the device usage condition may indicate at least one of a geographical location range or a usage time range corresponding to the palm-scanning device to be used. For example, the displayed palm-scanning device prompt information may be “Within 24 hours, an offline palm-scanning device senses an enrolled palm, and formally starts the service”, thereby limiting that the object needs to go to the offline palm-scanning device within 24 hours to enroll the palm data, to complete activation of the palm-scanning service for the target account. Alternatively, the displayed palm-scanning device prompt information may be “A palm-scanning device in an XX store senses the enrolled palm within 24 hours, and formally opens the service”, thereby limiting that the object needs to go to a palm-scanning device in a specific store within 24 hours to enroll the palm data, to complete activation of the palm-scanning service for the target account. The foregoing geographical location range and usage time range are only examples, and may be specifically set according to actual service requirements. This is not limited in the embodiments of this disclosure.

In some examples, the palm-scanning device prompt information may be displayed by using a separate prompt interface. For example, in response to the pre-activation operation triggered by the object on the palm-scanning service, the prompt interface may be first displayed, the object is prompted by using the prompt interface that the object currently performs palm pre-enrollment for activating the palm-scanning service, and the foregoing palm-scanning device prompt information is displayed in the prompt interface. Alternatively, the foregoing palm-scanning device prompt information may be directly displayed in the palm enrollment interface. A display position and a display manner of the palm-scanning device prompt information are not limited in the embodiments of this disclosure.

In this way, the device usage condition that needs to be satisfied when the palm-scanning service is activated for the target account is further set, and the device usage condition is used to limit that the object needs to use the palm-scanning device to enroll the palm data in a specific geographical location range and/or usage time range, to complete activation of the palm-scanning service for the target account, thereby further improving a requirement of activating the palm-scanning service, and improving security of activating the palm-scanning service. In addition, the usage time range is specified by using the device usage condition, that is, it is equivalent to that a storage time of the pre-enrolled palm data is set for the backend server. If the object does not go to the offline palm-scanning device to enroll the palm data within the usage time range, the server may consider that the pre-enrolled palm data previously enrolled by the object by using the terminal is invalid, and clean the pre-enrolled palm data, thereby releasing storage space in time and properly using storage resources.

In a possible implementation, the method provided in the embodiments of this disclosure may further include:
displaying triggering gesture enrollment prompt information, the triggering gesture enrollment prompt information being configured for prompting enrollment of a triggering gesture, and the triggering gesture being a gesture configured for instructing the server to complete the activation operation on the palm-scanning service. A target triggering gesture made by the object is collected by using the palm enrollment interface.

That is, in the mechanism for activating the palm-scanning service provided in this embodiment of this disclosure, the object may further be supported to self-define the target triggering gesture. For example, after determining that the palm information in the image satisfies the palm enrollment condition, and capturing the image satisfying the image quality condition, the terminal may display the triggering gesture enrollment prompt information in the palm enrollment interface, for example, display “Please make a self-defined triggering gesture in front of the camera, and make the triggering gesture again when collection by using the offline palm-scanning device to complete activation of the palm-scanning service”. Correspondingly, the object may make the self-defined target triggering gesture in the image capturing region of the camera, and the palm enrollment interface also correspondingly displays an image including the target triggering gesture captured by the camera. The object may confirm the target triggering gesture displayed in the palm enrollment interface, thereby completing definition of the target triggering gesture.

When the object goes to the offline palm-scanning device to complete activation of the palm-scanning service for the target account, the object may make the target triggering gesture self-defined by the object in the image capturing region of the palm-scanning device. After the server detects the target triggering gesture based on the palm data collected by the palm-scanning device, it may be considered that the object has previously completed the pre-activation operation on the palm-scanning service by using the terminal. In this case, the server may directly use the palm data collected by the palm-scanning device to search for the matching pre-enrolled palm data, to complete activation of the palm-scanning service for the corresponding account.

In some examples, a specific triggering gesture may also be directly specified without self-definition of the target object. For example, the terminal may directly display triggering gesture prompt information, indicate the specific triggering gesture by using the triggering gesture prompt information, and prompt the object to make the triggering gesture when using the palm-scanning device offline for the first time, to complete activation of the palm-scanning service.

In this way, by setting the triggering gesture, for example, a triggering gesture self-defined by the object or a specific triggering gesture specified by the object, it facilitates the server in the backend to more quickly learn that activation processing on the palm-scanning service needs to be currently performed. That is, the server may directly perform a corresponding activation process of the palm-scanning service based on a detected triggering gesture without determining whether the palm-scanning service needs to be currently provided or the palm-scanning service needs to be activated, thereby improving efficiency of activating the palm-scanning service.

The method for activating a palm-scanning service provided in the embodiments of this disclosure proposes a mechanism for pre-activating a palm-scanning service by using a personal terminal. In this method, an object may preliminarily perform pre-enrollment on palm data by using a target application on a terminal, to enable a server to initially record an association between a target account currently logged in on the target application and the pre-enrolled palm data collected by the terminal. When the object uses a palm-scanning device offline, the server may automatically determine and record an association between palm data collected by the palm-scanning device and the target account based on a match relationship between the palm data collected by the palm-scanning device and the preliminarily recorded pre-enrolled palm data, and the association between the pre-enrolled palm data and the target account. In this way, an activation operation on the palm-scanning service for the target account is completed. For the object, the palm data may be conveniently pre-enrolled preliminarily by using the personal terminal. When the palm-scanning device is used, activation of the palm-scanning service may be completed seamlessly without additional interaction with the palm-scanning device offline. Activation of the palm-scanning service is highly efficient, experience is good, and other objects are not affected from using the palm-scanning device. In addition, since the foregoing process of activating the palm-scanning service does not require the palm-scanning device to display any special content, display requirements on the palm-scanning device are reduced, thereby correspondingly lowering deployment and maintenance costs of the device.

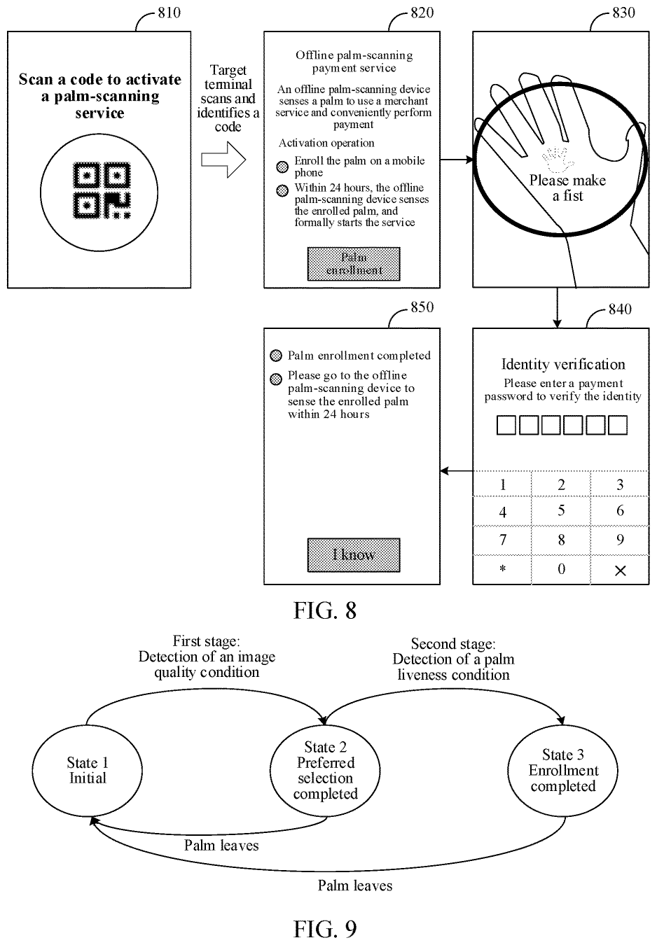

For ease of further understanding the foregoing method for activating a palm-scanning service on the terminal side, the following takes activation of a palm-scanning payment service as an example to describe the overall method for activating a palm-scanning service on the terminal side with reference to a schematic diagram of an interface of the terminal side during pre-activation of a palm-scanning service shown in FIG. 8.

As shown in FIG. 8, the object may use a code scanning function provided by the target application running on the terminal, to scan a QR code 810 configured for triggering activation of a palm-scanning payment service. The QR code 810 may, for example, be deployed on a promotional poster in a store. After the terminal successfully scans and identifies the QR code 810, a prompt interface 820 may be displayed. The prompt interface 820 may include introduction information of the palm-scanning payment service and an activation operation of the palm-scanning payment service. The activation operation may specifically include “Enroll a palm on the mobile phone” and palm-scanning device prompt information “Within 24 hours, an offline palm-scanning device senses an enrolled palm, and formally starts the service”. The object may trigger the pre-activation operation on the palm-scanning service by clicking a control of enrolling a palm in the prompt interface 820.

In response to the click operation performed by the object on the control of enrolling a palm, the terminal may display a palm enrollment interface 830 by using the target application. The palm enrollment interface 830 displays an image captured by the camera of the terminal. Corresponding prompt information may be displayed in the palm enrollment interface 830 according to the current palm state of the object, to prompt the object to control the palm to be in a required state.

The terminal detects whether the palm information in the image captured by the camera satisfies the palm enrollment condition. If it is detected that the palm information satisfies the palm enrollment condition, an identity verification interface 840 may be displayed. In the identity verification interface 840, the object is required to enter a payment password of the target account currently logged in on the target application, to verify the association relationship between the object and the target account. If verification succeeds, the terminal may display a result enrollment interface 850. The result enrollment interface 850 includes pre-enrollment success prompt information, to prompt the object that the server has been notified to record the pre-enrolled palm data corresponding to the target account. The result enrollment interface 850 further includes the palm-scanning device prompt information, to prompt the object again to complete activation of the palm-scanning service for the target account, and need to go to the offline palm-scanning device within a specific time to enroll higher-quality of palm data.

Next, a detection mechanism for determining whether the palm information of the object in the image satisfies the palm enrollment condition is described in detail. As described above, the palm enrollment condition in the embodiments of this disclosure may include the image quality condition and the palm liveness condition. Quality of the enrolled pre-enrolled palm data may be controlled according to the image quality condition. That is, an image including palm feature information of high quality may be selected by using the image quality condition. The pre-enrolled palm data is determined based on the image, so that the pre-enrolled palm data of high quality can be correspondingly obtained, and it is convenient to subsequently complete activation of the palm-scanning service by matching the palm data collected by the palm-scanning device based on the palm data collected by the palm-scanning device. Whether the palm in the currently captured image is a living body may be determined by using the palm liveness condition, to defend against a case that an unauthorized user uses a non-living palm to attack, that is, improve the likelihood that the enrolled pre-enrolled palm data corresponds to a living palm.

In some examples, detection of the image quality condition and detection of the palm liveness condition may be performed on the image in stages. FIG. 9 is a schematic diagram of detection of a palm enrollment condition according to an embodiment of this disclosure. As shown in FIG. 9, detection of the image quality condition may be performed in a first stage, to detect whether palm information in an image captured by the terminal in the first stage satisfies the image quality condition, to obtain an image satisfying the image quality condition. The image may be subsequently used as a basis for determining the pre-enrolled palm data by the server. Further, a second stage may be entered to perform detection of the palm liveness condition, to detect whether a palm in an image obtained by the terminal in the second stage is a living palm, and in a case that it is determined that the palm is the living palm, the image that satisfies the image quality condition and that is obtained in the first stage may be transmitted to the server, so that the server completes enrollment of the pre-enrolled palm data.

During the first stage and the second stage, if it is detected, based on the image captured by the terminal, that the palm leaves, an initial state needs to be returned to, and the first stage and the second stage are performed again from the initial state, to sequentially determine the image satisfying the image quality condition and detect whether the palm in the image is the living palm. That is, once it is detected that the palm leaves, detection of the image quality condition and detection of the palm liveness condition are performed again, to prevent a non-living palm from attacking in this process.

The following separately describes a detection mechanism of the image quality condition and a detection mechanism of the palm liveness condition in detail.

When detection of the image quality condition is performed, respective quality evaluation results of a plurality of frames of images captured by the camera of the terminal may be determined according to reference indicator information respectively corresponding to the plurality of frames of images; and according to the respective quality evaluation results of the plurality of frames of images, whether the palm information of the object in the image satisfies the image quality condition is determined. In some examples, respective quality evaluation results of a plurality of candidate images captured by the camera are determined, where one of the plurality of candidate images may be determined as the image for obtaining the pre-enrolled palm data. In some examples, based on the respective quality evaluation results, whether the palm information obtained from the image satisfies the image quality condition may be determined.

That is, for the plurality of frames of images captured by the camera of the terminal in the first stage, the reference indicator information respectively corresponding to the plurality of frames of images may be determined. The reference indicator information is indicator information that can measure whether the image satisfies the image quality condition, and may be, for example, information related to the palm in the image or image quality information of the image. Then, quality evaluation may be respectively performed, by using a preset quality evaluation mechanism, on the plurality of frames of images according to the reference indicator information respectively corresponding to the plurality of frames of images captured by the camera, to obtain the quality evaluation results respectively corresponding to the plurality of frames of images. Further, whether an image whose corresponding quality evaluation result satisfies a reference quality evaluation result exists may be determined according to the quality evaluation results respectively corresponding to the plurality of frames of images and the reference quality evaluation result (if the reference quality evaluation result is satisfied, it may be considered that the image quality condition is satisfied) indicated by the image quality condition. If it is determined that the image exists, the image whose corresponding quality evaluation result reaches the reference quality evaluation result is an image satisfying the image quality condition. That is, it may be determined that the palm information of the object in the image satisfies the image quality condition.

In a possible implementation, the quality evaluation result of the image may be determined in the following manner:
for each frame of image, determining the quality evaluation result of the image according to at least one piece of reference indicator information among palm direction information in the image, palm movement speed information, position relationship information between the palm and a reference boundary, or image quality information of the image.

The palm direction information refers to a placement direction of the palm in the image, and may be specifically an included angle between a connection line between two specific key points in the palm and an x-axis of the image, or may be an included angle between a connection line between two specific key points in the palm and a y-axis of the image. The placement direction of the palm in the image can determine, to some extent, whether the palm feature data can be accurately extracted from the image by using a subsequent palm feature extraction algorithm. Therefore, when quality of the basic image is evaluated, evaluation may be performed with reference to the palm direction information in the image.

The palm movement speed information refers to a movement speed of the palm in the image, and may be specifically calculated according to a change of a position of the palm in the image relative to a position of the palm in a frame of image adjacent to the image and a sampling interval between the two frames of images. In some examples, an excessively fast movement speed of the palm causes blurring of camera sampling, that is, blurring of palm display in the image. The blurring of palm display in the image affects subsequent extraction of the palm feature data, making it difficult to accurately extract the palm feature data. Therefore, when quality of the image is evaluated, evaluation may be performed with reference to the palm movement speed information in the image.

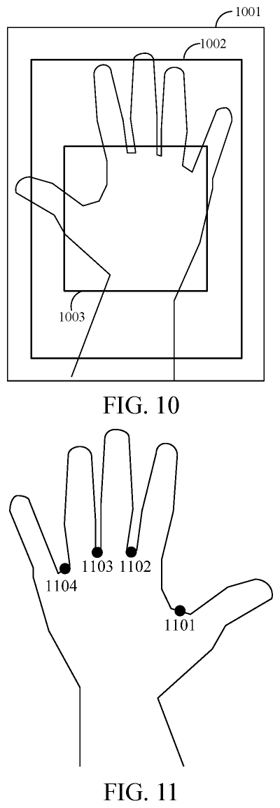

The position relationship information between the palm and the reference boundary is configured for representing whether the palm is entirely located in the preset reference boundary. For example, FIG. 10 is a schematic diagram of determining a position relationship between a palm and a reference boundary according to an embodiment of this disclosure. As shown in FIG. 10, a box 1001 is a size of an image, a box 1002 is a preset reference boundary, and a box 1003 indicates a region in which the palm in the image is currently located. Detection of the position relationship between the palm and the reference boundary may correspond to detecting whether the box 1003 is entirely located in the box 1002. Whether the palm is located in a center region of the image can determine, to some extent, whether the palm feature data can be accurately extracted from the image by using the subsequent palm feature extraction algorithm. Therefore, when quality of the image is evaluated, evaluation may be performed with reference to the palm direction information in the image.

The image quality information of the image refers to image quality of the image, for example, the image quality is reflected by using indicators such as a definition, a resolution, a mean square error, and a peak signal-to-noise ratio of the image. In this embodiment of this disclosure, the image quality of the image may be evaluated by using an image quality evaluation algorithm or model. The image quality of the image determines display quality of the palm. When the image quality of the image is low, the display quality of the palm is not very high. Therefore, when the image quality is evaluated, the image quality information of the image may be referred to for evaluation.

When the quality evaluation result of the image is specifically determined, at least one information of the palm direction information, the palm movement speed information, the position relationship information between the palm and the reference boundary, or the image quality information of the image may be referred to. The palm direction information, the palm movement speed information, the position relationship information between the palm and the reference boundary, or the image quality information of the image may be referred to at the same time to evaluate the image, to determine the image quality evaluation result of the image more comprehensively from a plurality of perspectives.

For example, when the image is evaluated with reference to the palm direction information, the palm movement speed information, the position relationship information between the palm and the reference boundary, and the image quality information of the image at the same time, a corresponding direction scoring mechanism may be preset for the palm direction information, a corresponding movement speed scoring mechanism may be preset for the palm movement speed information, a position scoring mechanism may be preset for the position relationship information between the palm and the reference boundary, and an image quality scoring mechanism may be preset for the image quality information of the image. Correspondingly, the foregoing scoring mechanism may be used to determine a palm direction score, a movement speed score, a position score, and an image quality score corresponding to the image according to the actual palm direction information, palm movement speed information, position relationship information between the palm and the reference boundary, and image quality information in the image, and weighted summation processing is performed on these scores according to a preset weighting mechanism, to obtain an overall quality score corresponding to the image as the quality evaluation result of the image.

In this way, in the foregoing manner, the image may be evaluated from at least one perspective of a palm direction, a palm movement speed, a position of the palm in the image, or image quality of the image, to determine whether the image satisfies the image quality condition and whether the image is suitable for being used as a basis for extracting the pre-enrolled palm data, thereby providing a reliable mechanism for evaluating the image.

As an example, the palm direction information in the image may be determined in the following manner:
determining palm localization information in the image by using a depth detection algorithm; determining position information of a first key point in the image based on the palm localization information; and determining the palm direction information in the image according to the position information of the first key point in the image.

Specifically, the palm in the image may first be detected and localized by using a depth detection algorithm. For example, the palm in the image may be detected by using a You Only Look Once (YOLO) target detection algorithm, a Single Shot MultiBox Detector (SSD) target detection algorithm, and the like, to determine whether the palm exists in the image, and if it is determined that the palm exists, coordinate information of a palm center and a boundary in the image is determined.

Then, palm registration may be performed based on the previously obtained palm localization information, to determine the position information of the first key point in the image. For the first key point, specifically refer to a point 1101, a point 1102, a point 1103, and a point 1104 in FIG. 11. That is, four finger joint points may be used as the first key points. Specifically, the first key point in the image may be determined by using a DeepPose algorithm.

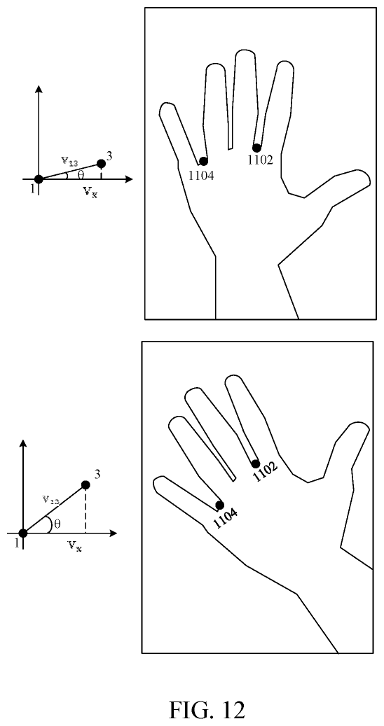

Further, based on the position information of the first key point, the palm direction information of the image may be determined. FIG. 12 is a schematic diagram of determining palm direction information according to an embodiment of this disclosure. As shown in FIG. 12, two first key points may be selected from the determined four first key points, for determining the palm direction information. For example, the point 1102 and the point 1104 are selected to determine the palm direction information. When the palm direction information is determined, an included angle between a connection line between the two selected first key points and an x-axis of the image may be calculated, and the included angle is used as the palm direction information. Specifically, calculation may be performed by using the following formula:

$$θ = \frac{acos ( c )}{2 π \times 360}$$

$$c = \frac{{v}_{13} \cdot {v}_{x}}{\vert {v}_{13} \vert \times \vert {v}_{x} \vert}$$

where θ is palm direction information, v₁₃ is a distance between two first key points, vₓ is a distance between respective projection points of the two first key points on the x-axis.

As an example, the palm movement speed information in the image may be determined in the following manner:
determining palm localization information in the image by using a depth detection algorithm; determining position information of a first key point in the image based on the palm localization information; and determining the palm movement speed information according to the position information of the first key point in the image and position information of a first key point in a frame of image adjacent to the image.

Specifically, an implementation of determining the position information of the first key point in the image is described above in detail, and details are not described herein again. After the position information of the four first key points in the image is determined, the palm movement speed information in the image may be determined according to position changes of the four first key points in the image relative to positions of the four first key points in a previous frame of image. Specifically, a movement speed corresponding to each first key point may be calculated by using the following formula:

$$v = \frac{\sqrt{{( {x}_{1} - {x}_{2} )}^{2} + {( {y}_{1} - {y}_{2} )}^{2}}}{dt}$$

v is a movement speed corresponding to a single first key point, x₁ and x₂ are respectively a horizontal coordinate of the first key point in a current frame of image and a horizontal coordinate of the first key point in a previous frame of image, y₁ and y₂ are respectively a vertical coordinate of the first key point in the current frame of image and a vertical coordinate of the first key point in the previous frame of image, and t is a time interval between the current frame of image and the previous frame of image.

After the movement speeds respectively corresponding to the four first key points are obtained through calculation in the foregoing manner, averaging processing may be performed on the movement speeds respectively corresponding to the four first key points, and an obtained average speed is used as the palm movement speed information in the image.

When the quality evaluation result of the image needs to be determined based on the palm direction information and the palm movement speed information, detection processing on the first key point of the image may be performed only once, to further determine the palm direction information and the palm movement speed information according to the detected first key point.

In this way, in the foregoing manner, the palm in the image is detected by using the depth detection algorithm, the first key point on the palm is determined, and the palm direction and/or the palm movement speed in the image is determined according to the first key point, to improve the likelihood that the determined palm direction and/or palm movement speed is accurate, thereby facilitating accurate evaluation on the image.

As an example, the image quality information of the image may be determined in the following manner:
determining an image quality score of the image according to the image by using a palm image evaluation model, the palm image evaluation model being trained based on a training palm image and a corresponding annotation score, and the annotation score being determined according to a difference between the training palm image and a corresponding reference palm image.

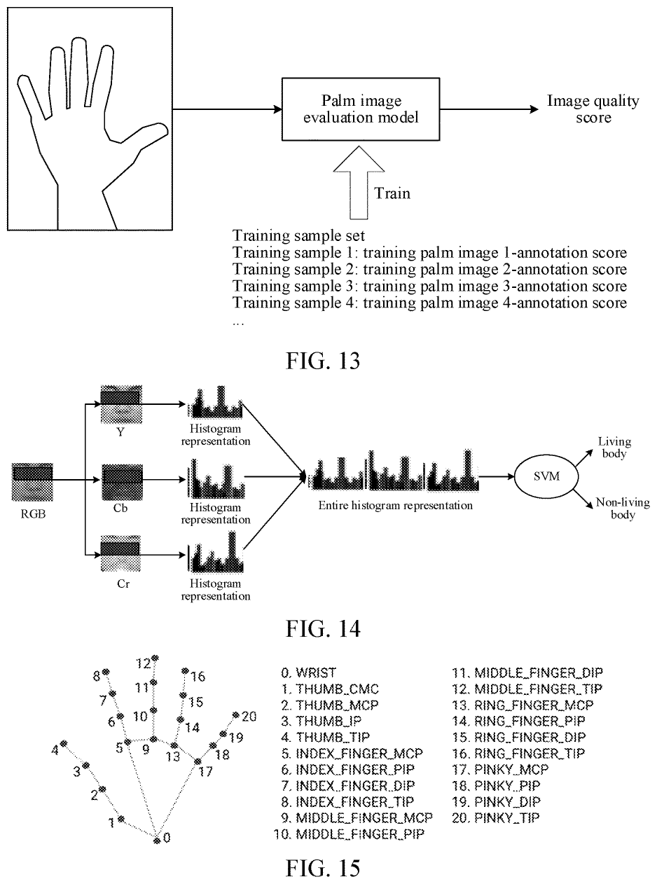

Specifically, FIG. 13 is a schematic diagram of determining image quality information according to an embodiment of this disclosure. As shown in FIG. 13, the image may be directly inputted into a pre-trained palm image evaluation model. The palm image evaluation model may correspondingly output the image quality score corresponding to the image by analyzing and processing the image. The image quality score is configured for representing quality of the image as a whole.

The palm image evaluation model is obtained by training based on a pre-constructed training sample set. The training sample set includes a large quantity of training samples. Each training sample includes the training palm image and the annotation score corresponding to the training palm image. The annotation score is determined according to the difference between the training palm image and the reference palm image corresponding to the training palm image (that is, a palm image having high quality is used as a reference standard, and the palm included in the reference palm image is the same as the palm in the training palm image corresponding to the reference palm image). For example, the annotation score corresponding to the training palm image may be determined according to information such as an exposure difference and a distortion degree of the training palm image relative to the reference palm image.

When the palm image evaluation model is trained, the training palm image in the training sample may be inputted to a to-be-trained palm image evaluation model, to obtain a predicted score outputted by the palm image evaluation model. Further, a loss function may be constructed according to a difference between the predicted score and the annotation score in the training sample, and a model parameter of the palm image evaluation model is adjusted based on the loss function, thereby training the palm image evaluation model.

The foregoing palm image evaluation model may be any neural network model that can analyze and process an image, for example, a neural network model configured to evaluate face image quality. A model structure of the palm image evaluation model is not limited in the embodiments of this disclosure.

In this way, image quality of the entire image is determined by using the pre-trained palm image evaluation model. Since the palm image evaluation model may have high robustness, palm images captured in various scenarios can be accurately evaluated, thereby improving robustness of an image quality evaluation system.

As described above, when recording the pre-enrolled palm data corresponding to the target account, the server needs to extract a palm feature based on the image satisfying the image quality condition, and use the extracted palm feature data as the pre-enrolled palm data. Based on obtaining the respective quality evaluation results of the plurality of frames of images in the foregoing manner, the pre-enrolled palm data corresponding to the target account may be determined in the following manner:
determining an image among the plurality of frames of images according to the respective quality evaluation results of the plurality of frames of images; and extracting palm feature data in the determined image as the pre-enrolled palm data corresponding to the target account.

Specifically, in a case that it is determined, according to the respective quality evaluation results of the plurality of frames of images, that images satisfying the preset image quality condition exist, the determined image may be determined from the images satisfying the image quality condition. For example, assuming that the quality evaluation result of the image is an overall quality score, an image having a highest overall quality score may be selected from the frames of images as the determined image. Further, the determined image is transmitted to the server. The server performs palm feature extraction processing on the determined image, to obtain the palm feature data in the determined image, and uses the palm feature data as the pre-enrolled palm data corresponding to the target account.

In this way, the determined image having the best quality is selected and the server determines, according to the determined image, the pre-enrolled palm data corresponding to the target account, to enhance the quality of the palm pre-enrolled palm data, thereby facilitating subsequently accurately detecting, based on the pre-enrolled palm data, that the object uses the offline palm-scanning device, and correspondingly completing activation of the palm-scanning service for the object.

When detection of the palm liveness condition is performed, whether the palm information of the object in the image satisfies the palm liveness condition is detected by using the liveness detection mechanism and based on the palm information of the object in the image. In some examples, based on a liveness detection mechanism and based on the palm information obtained from the image, whether the palm information satisfies the palm liveness condition may be determined.

Specifically, the liveness detection mechanism configured for detecting whether the palm in the image is a living palm may be first set. The liveness detection mechanism may be a detection mechanism based on a feature of the image, or may be a detection mechanism based on a palm action in the image. This is not limited in the embodiments of this disclosure. Then, the palm in the image is detected based on the foregoing liveness detection mechanism, to determine whether the palm is a living palm, thereby determining whether the palm information in the image satisfies the palm liveness condition.

As an example, whether the palm information in the image satisfies the palm liveness condition is determined in the following manner:
determining an image feature of the image in a preset color space; and determining, by using a liveness discrimination model and according to the image feature, whether the palm in the image is a living palm.

Specifically, considering that a living palm and a non-living palm are usually difficult to distinguish in an RGB space, and have an apparent texture difference in another color space, for example, a texture difference in an HSV (Hue, Saturation, Value) space and a YCbCr space, an image feature of the image in such a color space may be determined. Further, whether the palm in the image is a living body is determined based on the foregoing image feature by using the pre-trained liveness discrimination model.

FIG. 14 is a schematic diagram of living palm detection according to an embodiment of this disclosure. For ease of presentation, an example in which a detected image is a face image is used in FIG. 14. However, in this embodiment of this disclosure, the image that needs to be detected is to be a palm image. As shown in FIG. 14, color space conversion processing may be performed on an RGB image captured by the terminal, to obtain corresponding Y, Cb, and Cr images, and histogram representations respectively corresponding to the Y, Cb, and Cr images are determined. Then, the histogram representation respectively corresponding to the Y, Cb, and Cr images may be spliced, to obtain an overall histogram representation. Further, the overall histogram representation may be inputted to a pre-trained support vector machine (SVM) for performing liveness discrimination, and whether the palm in the basic image is a living palm is determined by using the support vector machine.

In this way, whether the palm information in the image satisfies the palm liveness condition is detected in the foregoing manner, so that an obtained detection result may have higher accuracy, and the object triggering activation of the palm-scanning service by using the terminal may not need to be instructed to perform a specific liveness verification action, thereby simplifying a palm enrollment process on the terminal side.

As another example, whether the palm information in the image satisfies the palm liveness condition is determined in the following manner:
determining second key points in the image by using a gesture detection algorithm, and determining a gesture in the image according to a relative position relationship between the second key points; and determining, if the gesture in the image matches the liveness verification action, that the palm in the image is the living palm.

As described above, during palm enrollment by using the palm enrollment interface, the verification prompt information may be displayed to instruct the object currently enrolling the palm to control the palm to perform a specific liveness verification action. Correspondingly, whether the action that the object actually controls the palm to perform is the same as the indicated liveness verification action may be determined in the foregoing manner.

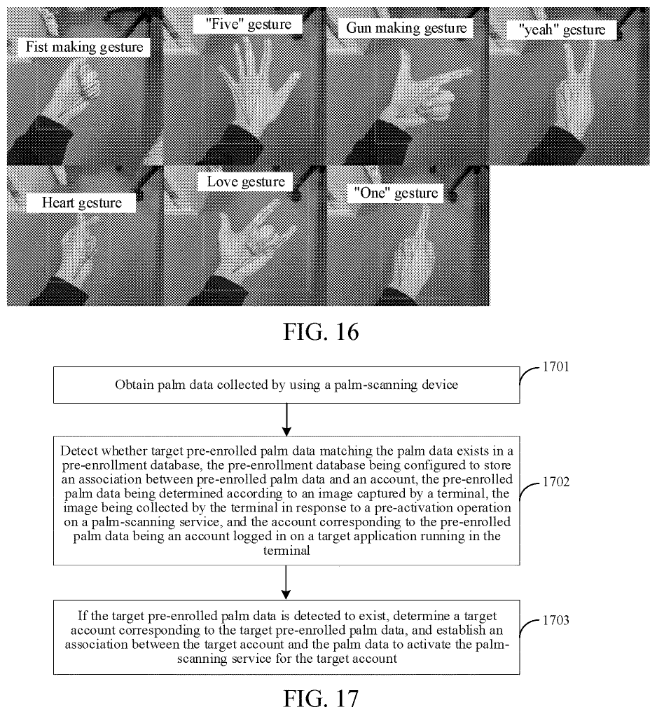

That is, a gesture detection algorithm such as a MediaPipe hands algorithm may be used to detect the second key points on the palm in the image. For the second key points, specifically refer to a point 0 to a point 20 in FIG. 15. As shown in FIG. 16, a gesture of the palm in the image may be accurately determined according to the relative position relationships between the foregoing twenty second key points. Further, whether the gesture of the palm in the image is the same as a gesture corresponding to the liveness verification action may be determined, to determine whether the palm in the image is a living palm. For example, assuming that the liveness verification action is making a fist, whether the palm in the image is a fist making gesture may be determined according to the relative position relationships between the twenty second key points in the image.

In this way, in the foregoing manner, the gesture in the image is detected by using the gesture detection algorithm, and whether the gesture is the same as the gesture indicated by the liveness verification action is determined, to determine whether the palm in the image is a living palm, so that living palm determining can be quickly performed, and a complex liveness detection algorithm does not need to be deployed.

In some examples, the liveness detection manners provided in the foregoing two examples may be used to detect whether the palm in the image is a living palm. For example, liveness detection is first performed based on the image feature in the preset color space, and then liveness detection is performed based on whether the gesture matches the liveness verification action. Alternatively, only one liveness detection manner provided in any one of the examples may be used to detect whether the palm in the image is a living palm. This is not limited in the embodiments of this disclosure.

An operation of detecting whether the palm information in the foregoing image satisfies the palm enrollment condition may be performed by the terminal, or may be performed by the server. The embodiments of this disclosure do not limit an entity performing this operation.

FIG. 17 is a schematic flowchart of a method for activating a palm-scanning service according to an embodiment of this disclosure. The method for activating a palm-scanning service may be performed by a server configured to manage and activate the palm-scanning service. As shown in FIG. 17, the method for activating a palm-scanning service includes the following operations.

Operation 1701: Obtain palm data collected by using a palm-scanning device. For example, sample palm data may be obtained through information collected by a palm-scanning device.

As described above, after completing the pre-activation operation on the palm-scanning service by using the target application in the terminal, the object may go to the offline palm-scanning device to formally activate the palm-scanning service. When the object uses the offline palm-scanning device, the palm-scanning device may correspondingly collect the palm data of the object. The palm-scanning device may transmit the palm data collected by the palm-scanning device to the server.

Operation 1702: Detect whether target pre-enrolled palm data matching the palm data exists in a pre-enrollment database, the pre-enrollment database being configured to store a correspondence between pre-enrolled palm data and an account, the pre-enrolled palm data being determined according to an image captured by a terminal, the image being captured by the terminal in response to a pre-activation operation triggered for a palm-scanning service, and the account corresponding to the pre-enrolled palm data being an account logged in on a target application running in the terminal. For example, whether target pre-enrolled palm data matching the sample palm data exists in a pre-enrollment database is determined by processing circuitry of a server device, the target pre-enrolled palm data being obtained from an image captured by a terminal through execution of a target application.

Operation 1703: If the target pre-enrolled palm data is detected to exist, determine a target account corresponding to the target pre-enrolled palm data, and establish an association between the target account and the palm data to activate the palm-scanning service for the target account. For example, when the target pre-enrolled palm data is determined to exist and the sample palm data is collected in compliance with a device usage condition, a target account stored in association with the target pre-enrolled palm data in the pre-enrollment database may be determined, establishing an association between the target account and the palm data to activate activating, by the processing circuitry, the palm-scanning service for the target account may be activated by the processing circuitry of the server device, and benchmark palm data for the target account according to the sample palm data may be recorded. In some embodiments, the benchmark palm data may be obtained from an image taken by the palm-scanning service within a visible-light spectrum, an image taken by the palm-scanning service within an infrared spectrum, or both.

Since operation 1702 is strongly related to operation 1703, implementations of the two operations are described below as a whole.

After receiving the palm data transmitted by the palm-scanning device, the server detects whether the target pre-enrolled palm data matching the palm data exists in the pre-enrollment database. If it is detected that the target pre-enrolled palm data matching the palm data exits, the object currently using the palm-scanning device has previously completed the pre-activation operation on the palm-scanning service by using the terminal. In this case, the server may determine the target account corresponding to the detected target pre-enrolled palm data in the pre-enrollment database, and determine that the palm data currently collected by the palm-scanning device corresponds to the target account. Therefore, the association between the target account and the palm data can be established and the association is stored, thereby completing activation of the palm-scanning service for the target account.

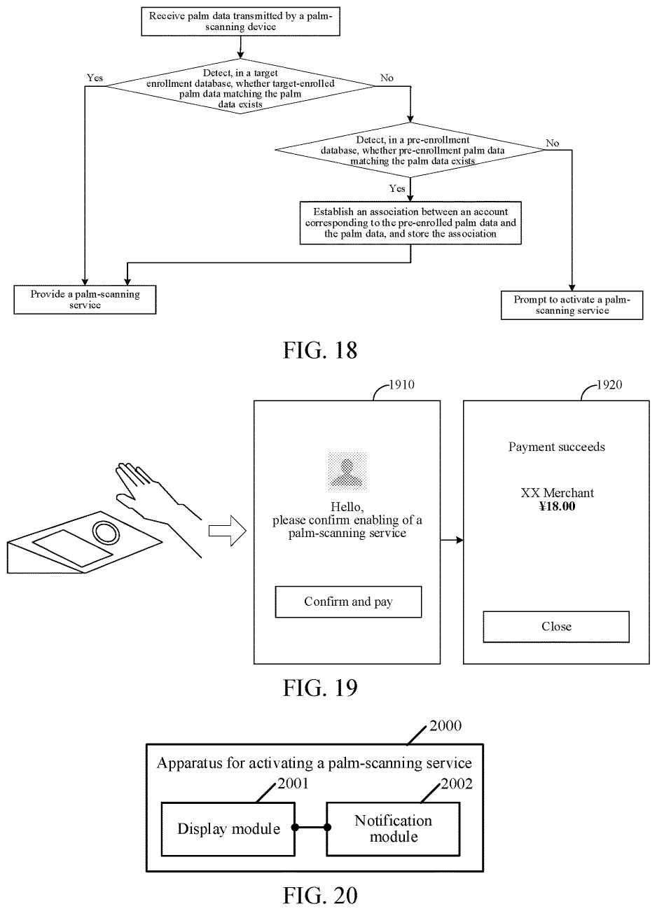

In some examples, the object using the palm-scanning device may alternatively be an object that has successfully activated the palm-scanning service. The object currently needs to use the palm-scanning service, but the server needs to take consideration of both providing the palm-scanning service and actuating the palm-scanning service, and a priority of providing the palm-scanning service is higher than a priority of actuating the palm-scanning service. Therefore, the server may specifically respond, by using the process shown in FIG. 18, to the palm data transmitted by the palm-scanning device, and provide a corresponding service for the object.

As shown in FIG. 18, after receiving the palm data transmitted by the palm-scanning device, the server may first detect, in a target enrollment database, whether the palm data matching the palm data exists. The target enrollment database stores an association between the palm data enrolled by using the palm-scanning device and an account, that is, the target enrollment database stores an association between an account that has activated the palm-scanning service and the palm data. In an example, the target enrollment database is preferentially used as a detection data source for matching the palm data compared with the pre-enrollment database. That is, the server first performs matching detection on the palm data transmitted by the palm-scanning device in the target enrollment database, and if the palm data is not detected, then perform matching detection in the pre-enrollment database.

If the palm data matching the palm data transmitted by the palm-scanning device is detected in the target enrollment database, the object currently using the palm-scanning device is the object that has activated the palm-scanning service, and currently needs to use the palm-scanning service. Based on this, the server may correspondingly provide the palm-scanning service for the object. If the palm data matching the palm data is not detected in the target enrollment database, the object currently using the palm-scanning device has not successfully activated the palm-scanning service. In this case, the server may detect whether the pre-enrolled palm data matching the palm data exists in the pre-enrollment database.

If the pre-enrolled palm data matching the palm data is detected in the pre-enrollment database, the object currently using the palm-scanning device has completed the pre-activation operation on the palm-scanning service by using the terminal. In this case, the palm data collected by the palm-scanning device may be used to complete the activation operation on the palm-scanning service for the object, that is, an association between the account corresponding to the pre-enrolled palm data and the palm data is established and the association is stored. If the pre-enrolled palm data matching the palm data is not detected in the pre-enrollment database, the object cannot currently use the palm-scanning device, and palm-scanning service activation prompt information may be displayed by using the palm-scanning device, to prompt the object to activate the palm-scanning service.

After establishing the association between the target account and the palm data, the server may store the association between the target account and the palm data into the target enrollment database, and delete an association between the target account and the target pre-enrolled palm data from the pre-enrollment database. Therefore, stored redundant data is reduced, and storage resources are properly and effectively used.

In a possible implementation, the target pre-enrolled palm data may be associated with a device usage condition to be satisfied when the palm-scanning service is activated for the target account, the device usage condition being configured for indicating at least one of a geographical location range or a usage time range corresponding to the palm-scanning device to be used. Correspondingly, the method provided in this embodiment of this disclosure further includes: detecting whether the palm-scanning device for collecting the palm data satisfies the device usage condition; and establishing the association between the target account and the palm data in a case that the palm-scanning device for collecting the palm data satisfies the device usage condition. In some examples, the device usage condition indicates that the sample palm data is collected through the palm-scanning device located within a geographical range or within a time range.

As described above, when the object pre-activates the palm-scanning service, the device usage condition when the object formally activates the palm-scanning service may further be specified for the object. In a case that the device usage condition is specified, the server may detect whether the palm-scanning device uploading the palm data satisfies the device usage condition, that is, may detect whether the palm-scanning device is located in the geographical location range specified by the device usage condition, and/or detect whether a use time of the palm-scanning device of the object is in the usage time range specified by the device usage condition. If it is detected that the device usage condition is satisfied, the server may complete the activation operation on the palm-scanning service for the target account, that is, establish and store the association between the target account and the palm data. Conversely, if it is determined, through detection, that the device usage condition is not satisfied, it is considered that the palm-scanning service fails to be activated.

In this way, by detecting whether the palm-scanning device collecting the palm data satisfies the corresponding device usage condition, a capability of defending against an unauthorized attack by the activation mechanism of the palm-scanning service can be enhanced, thereby improving security of activation of the palm-scanning service.

In a possible implementation, the method provided in this embodiment of this disclosure may further include controlling, by the server, the palm-scanning device to display activation verification information, the activation verification information being configured for instructing to trigger a verification operation; receiving operation content corresponding to the verification operation uploaded by the palm-scanning device; and determining, according to the operation content, whether to execute an operation of establishing the association between the target account and the palm data. In some examples, the palm-scanning device is controlled to display activation verification information, the activation verification information indicating an action to be performed to trigger a verification operation. In some examples, operation content from the palm-scanning device corresponding to the activation verification information is received. In some examples, whether to activate the palm-scanning service for the target account and to record the benchmark palm data for the target account according to the sample palm data may be determined according to the operation content.

Specifically, after the server detects the target pre-enrolled palm data matching the palm data in the pre-enrollment database, the palm-scanning device may be controlled to display the activation verification information, the activation verification information being configured for instructing the object to trigger the verification operation. For example, the palm-scanning device may be controlled to display activation verification information “Hello, please confirm enabling of the palm-scanning service”, and correspondingly display a confirmation control and a rejection control. The object may trigger enabling of the palm-scanning service by clicking the confirmation control. For another example, the palm-scanning device may be controlled to display activation verification information “Hello, please enter a tail number of a mobile phone number bound to the target account”, and correspondingly display a digit input control. The object may correspondingly enter, by using the digit input control, the tail number of the mobile phone bound to the target account.

After receiving the verification operation triggered by the object based on the activation verification information, the palm-scanning device may transmit the operation content of the verification operation to the server. For example, operation content indicating a click operation on the confirmation control is transmitted to the server. For another example, the entered mobile phone tail number is transmitted to the server. After receiving the operation content, the server may determine, according to the operation content, whether to activate the palm-scanning service for the target account. For example, assuming that the operation content indicates that the object triggers the click operation on the confirmation control, the server may correspondingly activate the palm-scanning service for the target account. For another example, assuming that the server verifies the mobile phone tail number carried in the operation content, and confirms that the mobile phone tail number is a tail number of a mobile phone number bound to the target account, the server may correspondingly activate the palm-scanning service for the target account.

In this way, the server may further determine, based on the verification operation triggered by the object in response to the activation verification information, whether the object confirms to activate the palm-scanning service for the target account, and determine whether an identity of the object is legal, thereby further improving reliability of the activation operation on the palm-scanning service, and avoiding a case that the palm-scanning service is activated by mistake or a lawbreaker activates the palm-scanning service.

In a possible implementation, after the server establishes an association between the target account and the palm data and activates the palm-scanning service for the target account, the method provided in this embodiment of this disclosure may further include providing the palm-scanning service based on the target account; and controlling the palm-scanning device to display a service result corresponding to the palm-scanning service. For example, the palm-scanning service for the target account is rendered based on the benchmark palm data through the palm-scanning device. In some examples, the palm-scanning device is controlled to display a service result of the palm-scanning service.

In this embodiment of this disclosure, after completing the pre-activation operation on the palm-scanning service by using the terminal, the object may directly go to the offline palm-scanning device to use a corresponding palm-scanning service. In a process of using the palm-scanning service, the server may complete, based on the palm data collected by the palm-scanning device, the foregoing process of activating the palm-scanning service for the target account. However, the process of activating the palm-scanning service for the target account may be unperceived by the target object. That is, after activating the palm-scanning service for the target account, the server may directly provide, based on the target account, the palm-scanning service for the object currently using the palm-scanning device, and control the palm-scanning device to display a service result corresponding to the palm-scanning service.

In this way, after the palm-scanning service is activated for the target account, the corresponding palm-scanning service is directly provided based on the target account, and a seamless connection between activation of the palm-scanning service and provision of the palm-scanning service is implemented. This can improve efficiency of providing the palm-scanning service, and avoid affecting other users from using the palm-scanning device.

Using an example in which the palm-scanning service is a palm-scanning payment service, FIG. 19 is a schematic diagram of an interface of a palm-scanning device side according to an embodiment of this disclosure. As shown in FIG. 19, after the object completes the pre-activation operation on the palm-scanning payment service by using the terminal, the object may go to a merchant and use the palm-scanning payment service by using the palm-scanning device deployed at the merchant. After the object scans the palm by using the palm-scanning device, the palm-scanning device interacts with the server, and may display activation verification information “Hello, please confirm enabling of the palm-scanning service” in an interface 1910, and correspondingly display the confirmation control. If the click operation performed by the object on the confirmation control is received, interaction may be performed with the server, to directly provide the palm-scanning payment service for the object, to deduct corresponding money from an associated target account to complete payment, and an interface 1920 is displayed.

The method for activating a palm-scanning service provided in the embodiments of this disclosure proposes a mechanism for pre-activating a palm-scanning service by using a personal terminal. In this method, an object may preliminarily perform pre-enrollment on palm data by using a target application on a terminal, to enable a server to initially record an association between a target account currently logged in on the target application and the pre-enrolled palm data collected by the terminal. When the object uses a palm-scanning device offline, the server may automatically determine and record an association between palm data and the target account based on a match relationship between the palm data collected by the palm-scanning device and the preliminarily recorded pre-enrolled palm data, and the association between the pre-enrolled palm data and the target account. In this way, an activation operation on the palm-scanning service for the target account is completed. For the object, the palm data may be conveniently pre-enrolled preliminarily by using the personal terminal. When the palm-scanning device is used, activation of the palm-scanning service may be completed seamlessly without additional interaction with the palm-scanning device offline. Activation of the palm-scanning service is highly efficient, experience is good, and other objects are not affected from using the palm-scanning device. In addition, since the foregoing process of activating the palm-scanning service does not require the palm-scanning device to display any special content, display requirements on the palm-scanning device are reduced, thereby correspondingly lowering deployment and maintenance costs of the device.

For the method for activating a palm-scanning serviced described above, this disclosure further provides a corresponding apparatus for activating a palm-scanning service, so that the foregoing method for activating a palm-scanning service can be applied and implemented in practice.

FIG. 20 is a schematic diagram of a structure of an apparatus 2000 for activating a palm-scanning service corresponding to the method for activating a palm-scanning service shown in FIG. 2. As shown in FIG. 20, the apparatus 2000 for activating a palm-scanning service includes:
a display module 2001, configured to display, in response to a pre-activation operation on a palm-scanning service, a palm enrollment interface by using a target application running in a terminal, a target account being logged in on the target application;
the display module 2001 being further configured to display, in the palm enrollment interface, an image captured by a camera of the terminal; and
a notification module 2002, configured to notify, when it is determined that palm information of a target object in the image satisfies a palm enrollment condition, a server to record pre-enrolled palm data corresponding to the target account, the pre-enrolled palm data being determined according to the image, and the server being configured to activate, when palm data collected by a palm-scanning device matching the pre-enrolled palm data is detected, the palm-scanning service for the target account according to the palm data.

In some embodiments, the display module 2001 is further configured to:
display prompt information in the palm enrollment interface, the prompt information being configured for indicating an action to be performed by a palm to satisfy the palm enrollment condition.

In some embodiments, the display module 2001 is specifically configured to:
display position prompt information in the palm enrollment interface when the image does not include a palm, the position prompt information being configured for indicating a position at which a palm is to be located relative to the terminal;
display adjustment prompt information in the palm enrollment interface when the image includes the palm and a current placement state of a palm is inconsistent with a standard placement state, the adjustment prompt information being configured for indicating an action to be performed by the palm to change from the current placement state to the standard placement state; and
display verification prompt information in the palm enrollment interface when the image includes a palm and a current placement state of the palm is consistent with the standard placement state, the verification prompt information being configured for indicating a liveness verification action to be performed by the palm.

In some embodiments, the display module 2001 is specifically configured to:
display, in the palm enrollment interface, a first reference identifier corresponding to the standard placement state and a second reference identifier corresponding to the current placement state; and
display the adjustment prompt information according to a relationship between the first reference identifier and the second reference identifier, the adjustment prompt information being configured for indicating an action to be performed by the palm to adjust the second reference identifier to match the first reference identifier.

In some embodiments, the display module 2001 is further configured to:
display an identity verification interface by using the target application, the identity verification interface being configured to verify an association relationship between the object and the target account; and
the notification module 2002 is specifically configured to:
notify, when it is determined that the association relationship between the object and the target account passes verification, the server to record the pre-enrolled palm data corresponding to the target account.

In some embodiments, the display module 2001 is further configured to:
display palm-scanning device prompt information, the palm-scanning device prompt information being configured for indicating a device usage condition to be satisfied when the palm-scanning service is activated for the target account based on the pre-enrolled palm data, and the device usage condition being configured for indicating at least one of a geographical location range or a usage time range corresponding to the palm-scanning device to be used.

In some embodiments, the palm enrollment condition includes an image quality condition and a palm liveness condition; and the apparatus further includes a detection module, and the detection module is configured to determine whether the palm information of the object in the image satisfies the palm enrollment condition in the following manner:
determine respective quality evaluation results of a plurality of frames of images captured by the camera according to reference indicator information respectively corresponding to the plurality of frames of images; and determine, according to the respective quality evaluation results of the plurality of frames of images, whether the palm information of the object in the image satisfies the image quality condition; and
detect, by using a liveness detection mechanism and based on the palm information of the object in the image, whether the palm information of the object in the image satisfies the palm liveness condition.

In some embodiments, the detection module is specifically configured to:
for each frame of image, determine the quality evaluation result of the image according to at least one piece of reference indicator information among palm direction information in the image, palm movement speed information, position relationship information between the palm and a reference boundary, or image quality information of the image.

In some embodiments, the detection module is specifically configured to:
determine palm localization information in the image by using a depth detection algorithm;
determine position information of a first key point in the image based on the palm localization information; and
determine the palm direction information according to the position information of the first key point in the image; and/or determine the palm movement speed information according to the position information of the first key point in the image and position information of a first key point in a frame of image adjacent to the image.

In some embodiments, the detection module is specifically configured to:
determine an image quality score of the image according to the image by using a palm image evaluation model, the palm image evaluation model being trained based on a training palm image and a corresponding annotation score, and the annotation score being determined according to a difference between the training palm image and a corresponding reference palm image.

In some embodiments, the detection module is specifically configured to:
determine a basic image among the plurality of frames of basic images according to the respective quality evaluation results of the plurality of frames of basic images; and extract palm feature data in the determined basic image as the pre-enrolled palm data corresponding to the target account.

In some embodiments, the detection module is specifically configured to:
determine an image feature of the image in a preset color space; and
determine, by using a liveness discrimination model and according to the image feature, whether the palm in the image is a living palm.

In some embodiments, the detection module is specifically configured to:
determine second key points in the image by using a gesture detection algorithm, and determine a gesture in the image according to a relative position relationship between the second key points; and
determine, if the gesture in the image matches the liveness verification action, that the palm in the image is the living palm.

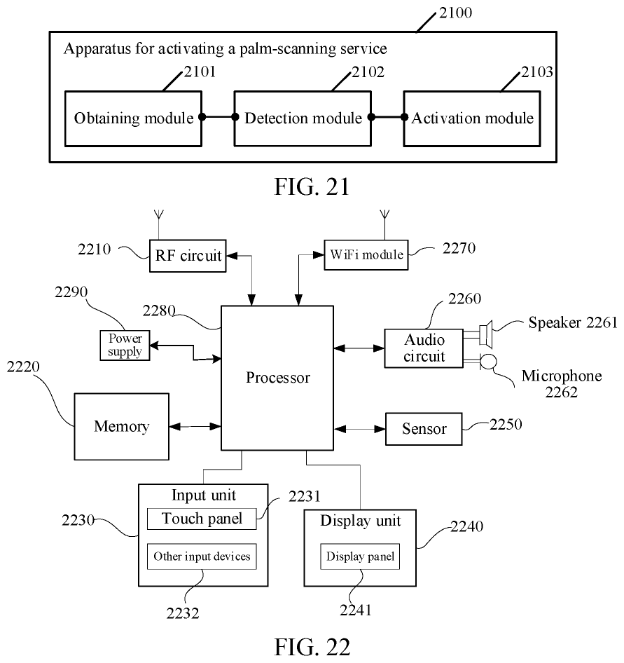

FIG. 21 is a schematic diagram of a structure of an apparatus 2100 for activating a palm-scanning service corresponding to the method for activating a palm-scanning service shown in FIG. 17. As shown in FIG. 21, the apparatus 2100 for activating a palm-scanning service includes:
an obtaining module 2101, configured to obtain palm data collected by using a palm-scanning device;
a detection module 2102, configured to detect whether target pre-enrolled palm data matching the palm data exists in a pre-enrollment database, the pre-enrollment database being configured to store an association between pre-enrolled palm data and an account, the pre-enrolled palm data being determined according to an image captured by a terminal, the image being captured by the terminal in response to a pre-activation operation on a palm-scanning service, and the account corresponding to the pre-enrolled palm data being an account logged in on a target application running in the terminal; and
an activation module 2103, configured to: if the target pre-enrolled palm data is detected to exist, determine a target account corresponding to the target pre-enrolled palm data, and establish an association between the target account and the palm data to activate the palm-scanning service for the target account.

In some embodiments, the target pre-enrolled palm data is associated with a device usage condition to be satisfied when the palm-scanning service is activated for the target account, the device usage condition being configured for indicating at least one of a geographical location range or a usage time range corresponding to the palm-scanning device to be used; and the detection module 2102 is further configured to:
detect whether the palm-scanning device for collecting the palm data satisfies the device usage condition; and
the activation module 2103 is specifically configured to:
establish the association between the target account and the palm data in a case that the palm-scanning device for collecting the palm data satisfies the device usage condition.

In some embodiments, the apparatus further includes a verification module, and the verification module is configured to:
control the palm-scanning device to display activation verification information, the activation verification information being configured for instructing to trigger a verification operation;
receive operation content corresponding to the verification operation uploaded by the palm-scanning device; and
determine, according to the operation content, whether to execute establishing the association between the target account and the palm data.

In some embodiments, the apparatus further includes a service provision module, and the service provision module is configured to:
after the establishing an association between the target account and the palm data to activate the palm-scanning service for the target account, provide the palm-scanning service based on the target account; and control the palm-scanning device to display a service result corresponding to the palm-scanning service.

In some embodiments, the apparatus further includes a data management module, and the data management module is configured to:
store the association between the target account and the palm data into a target enrollment database, and delete an association between the target account and the target pre-enrolled palm data from the pre-enrollment database,
the target enrollment database being configured to store an association between an account that has activated the palm-scanning service and the palm data, and the target enrollment database taking precedence over the pre-enrollment database as a data source for matching the palm data during verification.

This embodiment of this disclosure further provides a computer device configured to activate a palm-scanning service. Specifically, this computer device may be a terminal device or a server. The following introduces the terminal device and the server provided in this embodiment of this disclosure from a perspective of hardware materialization.

FIG. 22 is a schematic diagram of a structure of a terminal device according to an embodiment of this disclosure. As shown in FIG. 22, for ease of description, only a part related to this embodiment of this disclosure is shown. For a specific technical detail not disclosed, refer to the method part in the embodiments of this disclosure. The terminal may be any terminal device including a mobile phone, a tablet computer, a personal digital assistant (PDA), a point of sales (POS), and an on-board computer, and the terminal being a smartphone is used as an example.

FIG. 22 is a block diagram of a partial structure of a smart mobile phone related to a terminal according to an embodiment of this disclosure. In FIG. 22, the smartphone includes: a radio frequency (RF) circuit 2210, a memory 2220 (e.g., including a non-transitory computer-readable storage medium), an input unit 2230 (including a touch panel 2231 and another input device 2232), a display unit 2240 (including a display panel 2241), a sensor 2250, an audio circuit 2260 (may connect a speaker 2261 and a microphone 2262), a Wi-Fi module 2270, processing circuitry (e.g., a processor 2280), a power supply 2290, and other components. A person skilled in the art may understand that the structure the smartphone shown in FIG. 22 does not constitute a limitation on the smartphone, and the smartphone may include more components or fewer components than those shown in the figure, or some components may be combined, or a different component deployment may be used.

The memory 2220 may include a non-transitory computer-readable storage medium configured to store a software program and module. The processor 2280 runs the software program and module stored in the memory 2220, to implement various functional applications and data processing of the smartphone. The memory 2220 may mainly include a program storage region and a data storage region. The program storage region may store an operating system, an application program required by at least one function (for example, a sound playback function and an image display function), and the like. The data storage region may store data (for example, audio data and an address book) created based on the use of the smartphone, and the like. In addition, the memory 2220 may include a high speed random access memory, and may further include a non-volatile memory, such as at least one magnetic disk storage device, a flash memory device, or another volatile solid-state storage device.

The processor 2280 is a control center of the smartphone, and is connected to various parts of the entire smartphone by using various interfaces and lines. By running or executing the software program and/or the module stored in the memory 2220, and invoking data stored in the memory 2220, the processor 2280 executes various functions of the smartphone and performs data processing. In some embodiments, the processor 2280 may include one or more processing units. The processor 2280 may integrate an application processor and a modem processor. The application processor mainly processes an operating system, a user interface, an application program, and the like. The modem processor mainly processes wireless communication. The modem processor may not be integrated into the processor 2280.

In this embodiment of this disclosure, the processor 2280 included in the terminal is further configured to execute operations of any implementation of the method for activating a palm-scanning service provided on the terminal side in this embodiment of this disclosure.

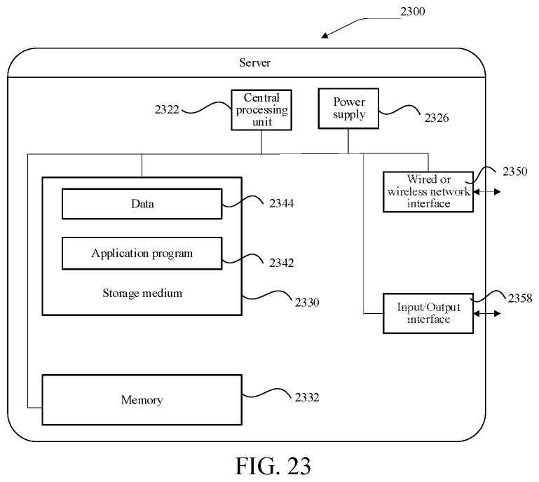

FIG. 23 is a schematic diagram of a structure of a server 2300 according to an embodiment of this disclosure. The server 2300 may vary greatly due different configurations or performance, and may include processing circuitry (e.g., one or more central processing units (CPU) 2322 including one or more processors) and a memory 2332, and one or more storage media 2330 (for example, one or more mass storage devices) that store application programs 2342 or data 2344. The memory 2332 and the storage medium 2330 may be a transient memory or a persistent memory. A program stored in the storage medium 2330 may include one or more modules (not shown in the figure), and each module may include a series of instruction operations for the server. Furthermore, the CPU 2322 may be configured to communicate with the storage medium 2330 to execute a series of instruction operations in the storage medium 2330 on the server 2300.

The server 2300 may further include one or more power supplies 2326, one or more wired or wireless network interfaces 2350, one or more input/output interfaces 2358, and/or one or more operating systems, for example, Windows Server™, Mac OS X™, Unix™ Linux™, or FreeBSD™.

The operations performed by the server in the foregoing embodiments may be based on the server structure shown in FIG. 23. The CPU 2322 may further be configured to execute operations of any implementation of the method for activating a palm-scanning service provided on the server side in the embodiments of this disclosure.

An embodiment of this disclosure further provides a non-transitory computer-readable storage medium, configured to store a computer program, the computer program being configured to perform any implementation in the method for activating a palm-scanning service described in the foregoing embodiments.

An embodiment of this disclosure further provides a computer program product or a computer program, the computer program product or the computer program including computer instructions, the computer instructions being stored in a non-transitory computer-readable storage medium. Processing circuitry (e.g., a processor) of a computer device reads the computer instructions from the non-transitory computer-readable storage medium. The processor executes the computer instructions, so that the computer device performs any implementation in the method for activating a palm-scanning service described in the foregoing embodiments.

A person skilled in the art can understand that for convenience and conciseness of description, for specific working processes of the foregoing systems, devices and units, reference may be made to the corresponding processes in the foregoing method embodiments, and details are not described herein again.

In the several embodiments provided in this disclosure, the disclosed system, apparatus, and method may be implemented in other manners. For example, the described apparatus embodiment is merely illustrative. For example, division into the units is merely logical function division and there may be another division manner in some examples. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, in other words, may be located in one position, or may be distributed on a plurality of network units. Some or all of the units may be selected based on actual requirements to achieve the objectives of solutions of embodiments.

In addition, functional units in the embodiments of this disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, all or some of the technical solutions described in this disclosure may be implemented in the form of a software product. The computer software product is stored in a storage medium and includes several instructions for instructing a computer device (which may be a personal computer, a server, or a network device) to perform all or some of the operations of the methods described in each embodiment of this disclosure. The foregoing storage medium includes: any medium that can store a computer program, such as a USB flash drive, a removable hard disk, a read-only memory (ROM), a random access memory (RAM), a magnetic disk, or an optical disc.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The foregoing embodiments are merely used for describing the technical solutions of this disclosure, but are not intended to limit this disclosure. Although this disclosure is described in detail with reference to the foregoing embodiments, a person skilled in the art is to understand that, modifications may still be made to the technical solutions described in the foregoing embodiments, or equivalent replacements may be made to the part of the technical features. These modifications or replacement, or related transformations and improvements, fall within the scope of this disclosure.

What is claimed is:

1. A method for activating a palm-scanning service, the method comprising:
displaying, based on a pre-activation operation in association with a target account for the palm-scanning service and through execution of a target application by processing circuitry of a terminal, a palm enrollment interface on a display of the terminal;
displaying, in the palm enrollment interface, an image captured by a camera of the terminal; and
notifying, when palm information obtained from the image satisfies a palm enrollment condition, a server to record pre-enrolled palm data for the target account based on the image, the server being configured to, when sample palm data for the target account collected separately from the image matches the pre-enrolled palm data, activate the palm-scanning service for the target account and record benchmark palm data for the target account according to the sample palm data.

2. The method according to claim 1, further comprising:
displaying prompt information in the palm enrollment interface, the prompt information indicating a proposed action based on the palm enrollment condition.

3. The method according to claim 2, wherein the displaying the prompt information in the palm enrollment interface comprises at least one of:
displaying position prompt information in the palm enrollment interface when the image does not depict a palm, the position prompt information indicating a position at which the palm is to be located relative to the terminal;
displaying adjustment prompt information in the palm enrollment interface when the image depicts the palm and indicates that a current placement state of the palm is inconsistent with a standard placement state, the adjustment prompt information indicating an action to be taken by the palm to change the palm from the current placement state to the standard placement state; or
displaying verification prompt information in the palm enrollment interface when the image depicts the palm and indicates that the current placement state of the palm is consistent with the standard placement state, the verification prompt information indicating a liveness verification action to be performed by the palm.

4. The method according to claim 3, wherein the displaying the adjustment prompt information in the palm enrollment interface comprises:
displaying, in the palm enrollment interface, a first reference identifier corresponding to the standard placement state and a second reference identifier corresponding to the current placement state; and
displaying, on the display, the adjustment prompt information according to a relationship between the first reference identifier and the second reference identifier, the adjustment prompt information indicating that the action to be taken by the palm corresponds to adjusting the second reference identifier to match the first reference identifier.

5. The method according to claim 1, further comprising:
displaying an identity verification interface through the execution of the target application by the processing circuitry, the identity verification interface being configured to verify an association relationship between the palm information and the target account,
wherein the notifying the server to record the pre-enrolled palm data for the target account includes:
notifying, when the association relationship between the palm information and the target account is successfully verified, the server to record the pre-enrolled palm data for the target account.

6. The method according to claim 1, further comprising:
displaying, on the display, palm-scanning device prompt information indicating a device usage condition for the activation of the palm-scanning service for the target account based on the pre-enrolled palm data, the device usage condition indicating that the sample palm data is collected through a palm-scanning device located within a geographical range or within a time range.

7. The method according to claim 1, wherein
the palm enrollment condition includes an image quality condition and a palm liveness condition, and
the method further includes:
determining respective quality evaluation results of a plurality of candidate images captured by the camera, one of the plurality of candidate images being determined as the image;
determining, based on the respective quality evaluation results, whether the palm information obtained from the image satisfies the image quality condition; and
detecting, based on a liveness detection and based on the palm information obtained from the image, whether the palm information satisfies the palm liveness condition.

8. The method according to claim 7, wherein the determining the respective quality evaluation results of the plurality of candidate images comprises:
for each candidate image, determining the quality evaluation result of the candidate image according to at least one of
palm direction information in the candidate image,
palm movement speed information,
position relationship information between the palm and a reference boundary, or
image quality information of the candidate image.

9. The method according to claim 8, further comprising, for one of the plurality of candidate images:
determining palm localization information in the candidate image by using a depth detection algorithm;
determining position information of a first key point in the candidate image based on the palm localization information;
determining at least one of
the palm direction information according to the position information of the first key point in the candidate image, or
the palm movement speed information according to the position information of the first key point in the candidate image and position information of a first key point in another one of the plurality of candidate images.

10. The method according to claim 8, further comprising, for one of the plurality of candidate images:
determining an image quality score of the candidate image based on a palm image evaluation model, the palm image evaluation model being trained based on a training palm image and a corresponding annotation score, and the annotation score being determined according to a difference between the training palm image and a corresponding reference palm image.

11. The method according to claim 7, further comprising:
determining the one of the plurality of candidate images as the image according to the respective quality evaluation results of the plurality of images; and
extracting palm feature data in the image as the pre-enrolled palm data for the target account.

12. The method according to claim 7, wherein the detecting whether the palm information obtained from the image satisfies the palm liveness condition comprises:
determining an image feature of the image in a preset color space; and
determining, by using a liveness discrimination model and according to the image feature, whether the palm depicted in the image corresponds to a living palm.

13. The method according to claim 7, wherein the detecting whether the palm information obtained from the image satisfies the palm liveness condition comprises:
determining second key points in the image based on a gesture detection algorithm;
determining a gesture in the image according to a relative position relationship among the second key points; and
determining, that the palm depicted in the image corresponds to a living palm when the gesture in the image matches a liveness verification action indicated through the palm enrollment interface.

14. A method for activating a palm-scanning service, the method comprising:
obtaining sample palm data through information collected by a palm-scanning device;
determining, by processing circuitry, whether target pre-enrolled palm data matching the sample palm data exists in a pre-enrollment database, the target pre-enrolled palm data being obtained from an image captured by a terminal through execution of a target application; and
when the target pre-enrolled palm data is determined to exist and the sample palm data is collected in compliance with a device usage condition:
determining a target account stored in association with the target pre-enrolled palm data in the pre-enrollment database;
activating, by the processing circuitry, the palm-scanning service for the target account; and
recording benchmark palm data for the target account according to the sample palm data.

15. The method according to claim 14, wherein
the device usage condition indicates that the sample palm data is collected through the palm-scanning device located within a geographical range or within a time range.

16. The method according to claim 14, further comprising:
controlling the palm-scanning device to display activation verification information, the activation verification information indicating an action to be performed to trigger a verification operation;
receiving operation content from the palm-scanning device corresponding to the activation verification information; and
determining, according to the operation content, whether to activate the palm-scanning service for the target account and to record the benchmark palm data for the target account according to the sample palm data.

17. The method according to claim 14, further comprising, after the palm-scanning service is activated for the target account:
rendering the palm-scanning service for the target account based on the benchmark palm data through the palm-scanning device; and
controlling the palm-scanning device to display a service result of the palm-scanning service.

18. The method according to claim 14, further comprising, after the palm-scanning service is activated for the target account:
storing an association between the target account and the benchmark palm data into a target enrollment database; and
deleting an association between the target account and the target pre-enrolled palm data from the pre-enrollment database.

19. An apparatus, comprising:
a camera;
a display; and
processing circuitry coupled to the display and the camera, and configured to:
display, based on a pre-activation operation in association with a target account for a palm-scanning service and through execution of a target application by the processing circuitry, a palm enrollment interface on the display;
display, in the palm enrollment interface, an image captured by the camera; and
notify, when palm information obtained from the image satisfies a palm enrollment condition, a server to record pre-enrolled palm data for the target account based on the image, the server being configured to, when sample palm data for the target account collected separately from the image matches the pre-enrolled palm data, activate the palm-scanning service for the target account and record benchmark palm data for the target account according to the sample palm data.

20. The apparatus according to claim 19, wherein the processing circuitry is further configured to:
display, on the display, palm-scanning device prompt information indicating a device usage condition for the activation of the palm-scanning service for the target account based on the pre-enrolled palm data, the device usage condition indicating that the sample palm data is collected through a palm-scanning device located within a geographical range or within a time range.
